(19) United States
(12) Patent Application Publication
(10) Pub. No.: US 2025/0165569 A1
(43) Pub. Date: May 22, 2025

(54) SYSTEMS AND METHODS FOR SECURE AUTHENTICATION

(71) Applicant: Netarx LLC, West Bloomfield, MI (US)

(72) Inventor: Sandy Kronenberg, West Bloomfield, MI (US)

(73) Assignee: Netarx LLC, West Bloomfield, MI (US)

(21) Appl. No.: 18/673,660

(22) Filed: May 24, 2024

Related U.S. Application Data
(63) Continuation-in-part of application No. 18/417,733, filed on Jan. 19, 2024.
(60) Provisional application No. 63/519,135, filed on Aug. 11, 2023.

(51) Int. Cl. G06F 21/31

(52) U.S. Cl. CPC G06F 21/31

(57) ABSTRACT

A system for authentication includes a validation system and an agent configured to communicate a first credential indicating an identification to the validation system and communicate a second credential indicating the identification to a verification service. The validation system includes a database configured to store authorized user data and a portal configured to provide selection of the verification service from a plurality of verification services. The validation system is configured to compare the first credential to the authorized user data, determine a confidence level of validity of the identification based on the comparison of the first credential to the authorized user data, receive a verification of the second credential from the verification service, and modify the confidence level based on the verification.

### CROSS-REFERENCE TO RELATED APPLICATIONS

This application claims the benefit of and priority to U.S. Non-Provisional patent application Ser. No. 18/417,733 filed on Jan. 19, 2024, the disclosure of which is hereby incorporated herein by reference in its entirety. This application claims the benefit of and priority to U.S. Provisional Patent Application No. 63/519,135 filed on Aug. 11, 2023, the disclosure of which is hereby incorporated herein by reference in its entirety.

### FIELD OF THE DISCLOSURE

The present disclosure generally relates to secure authentication and, more particularly, to systems and methods for authentication using non-repudiation for aggregation to detect deepfakes.

### BACKGROUND OF THE DISCLOSURE

Cybersecurity continues to be an important aspect in the digital world as the frequency and sophistication of cyberattacks increases. These cyberattacks can leverage Artificial Intelligence (AI) to create deepfakes that convince unsuspecting victims into sending money or allowing access to critical systems. Once access is given to critical systems, data is stolen and sold, often resulting in ransomware being implemented.

Conventional multifactor authentication methods may be vulnerable to quantum-computing-based attacks. Quantum computing is considered a potential risk to typical cryptographic systems because quantum computers have the potential to efficiently solve certain mathematical problems that form the basis of widely-used cryptographic algorithms. For example, typical public-key cryptography schemes can rely on the difficulty of factoring large numbers or solving certain mathematical problems that, while challenging for classical computing systems to solve, could nonetheless be solved by quantum computing systems.

The challenges posed by quantum computing to the security of cryptographic schemes can be demonstrated in various manners related to communication platforms, such as teleconferencing software, email, and instant-messaging applications. For example, spoofing in the form of deep-fake technology has undergone significant advancements, both in terms of its capabilities and potential implications. These sophisticated AI-driven algorithms can manipulate or synthesize media content, primarily images, and videos, to create hyper-realistic simulations of individuals, events, or scenarios. Deep-faking allows for seamless integration of people into fictional settings with the ability to mimic the voices and/or likeness of anyone. Furthermore, recent advances have allowed these technologies to be available with a single computer, no longer requiring massive computing farms to render complex computer graphics. Deep-Fake technologies are now widely accessible and very cost-effective.

The misuse of Deep-Fake technology for malicious purposes, such as spreading disinformation, forging evidence, or manipulating public opinion, poses a significant threat to society. As deep fakes become increasingly realistic and harder to detect, the risk of causing chaos, confusion, and harm amplifies. Additionally, there are growing concerns about privacy infringement, as individuals can be targeted by having their identities convincingly replicated without their consent. Addressing these challenges requires a multi-faceted approach involving robust detection mechanisms, clear regulations, and increased public awareness.

The emergence of deep fake technology has also introduced alarming risks to the realm of phishing schemes, making them significantly more sophisticated and dangerous. With the ability to convincingly impersonate someone's voice or appearance, malicious actors can now create highly realistic audio or video messages to deceive targets into revealing sensitive information, such as login credentials or financial details. As a result, phishing attacks are becoming more personalized, tailored to exploit individual trust, and manipulate victims into taking actions they would not have done otherwise. The enhanced realism of deep fakes poses a considerable challenge for traditional security measures, as people may find it increasingly difficult to discern between authentic and manipulated content, thereby falling victim to these cunning schemes. Therefore, there is more potential for reputational harm, fraud, or theft now than ever before. More importantly, the potential to gain access to critical infrastructure to gain access to financial, energy, government, or military systems is prominent.

To counter rampant thefts and/or scams, many Fedwire transfers now request verbal confirmation, as many financial institutions have been victims of fraud. Individuals, banks, title companies, Real-Estate Investment Trusts (REITs), and Lenders have all been victims of billions of dollars of fraud by sending wire transfers to pretenders. Now, with the advent of more and more sophisticated AI and Deep-Fake technologies, solutions are required to aid with the verification of trusted parties. Especially, with the advent of Zelle®, PayPal®, FedNow®, and other forms of digital instant transfers of fiat and crypto-currencies, a massive number of transactions are occurring 24 hours a day, 7 days a week without human supervision.

Consider a phone call or a video conference in which a participant is speaking to another participant; it could be awkward if the stream of the conversation needs to be stopped in order to verify the credentials of the other participant. Technology solutions are needed to combat these deep fake advances that go beyond the current two-factor authentication schemes in use today. Out-of-band authentication with private-public encryption keys are likely not post-quantum secure without additional security, and they can be too burdensome to use in a seamless and transparent way. To attempt to leverage existing two-factor authentication methods would be awkward, and there is no existing management of contracts.

### SUMMARY OF THE DISCLOSURE

According to one aspect of the present disclosure, a system for authentication includes a validation system and an agent configured to communicate a first credential indicating an identification to the validation system and communicate a second credential indicating the identification to a verification service. The validation system includes a database configured to store authorized user data and a portal configured to provide selection of the verification service from a plurality of verification services. The validation system is configured to compare the first credential to the authorized user data, determine a confidence level of validity of the identification based on the comparison of the first credential to the authorized user data, receive a verification of the second credential from the verification service, and modify the confidence level based on the verification.

According to one aspect of the present disclosure, a method for authentication includes selecting, via a portal of a validation system, a verification service from a plurality of verification services separate from the validation system, receiving, at the validation system, a first credential from an agent indicating an identification, comparing the first credential to authorized user data stored in an authorized user database, determining a confidence level of validity of the identification based on the comparison of the first credential to the authorized user data, communicating to the verification service a second credential from the agent indicating the identification, receiving, via the verification service, verification of the second credential, and modifying the confidence level based on the verification.

According to one aspect of the present disclosure, a method for authentication includes selecting a verification service from a plurality of verification services, receiving, at a validation system, a first credential from an agent indicating an identification, comparing the first credential to authorized user data, determining a confidence level of validity of the identification based on the comparison of the first credential to the authorized user data, communicating to the verification service a second credential indicating the identification, receiving a verification of the second credential from the verification service, and modifying the confidence level based on the validation.

According to one aspect of the present disclosure, a system for identity authentication on a communication platform includes a database configured to store authorized user data, a first node that creates an identification and is configured to communicate the identification, and at least one second node configured to receive the identification, compare the identification to the authorized user data, determine a confidence level for the first node, and communicate a signal indicating the confidence level. A user interface is configured to present an indication of the confidence level in response to the signal.

According to one aspect of the present disclosure, a system for identity authentication on a communication platform includes a database configured to store authorized user data, a first node configured to communicate the identification and communicate a credential to a verification service, and at least one second node configured to receive the identification, compare the identification to the authorized user data, determine a confidence level for the first node, receive a verification from the verification service based on the credential, update the confidence level based on the verification, and communicate a signal indicating the confidence level, and a user interface configured to present an indication of the confidence level in response to the signal.

According to one aspect of the present disclosure, a system for authentication includes a validation system and an agent configured to communicate a first credential indicating an identification to the validation system and communicate a second credential indicating the identification to a verification service. The validation system includes a database configured to store authorized user data and a portal configured to provide selection of the verification service from a plurality of verification services. The validation system is configured to compare the first credential to the authorized user data, determine a confidence level of validity of the identification based on the comparison of the first credential to the authorized user data, receive a verification of the second credential from the verification service, and modify the confidence level based on the verification.

According to one aspect of the present disclosure, a system for identity authentication on a communication platform includes a database configured to store authorized user data, a first node that creates an identification and is configured to communicate the identification, at least one second node configured to receive the identification, compare the identification to the authorized user data, determine a confidence level for the first node, and communicate a signal indicating the confidence level, and a user interface configured to present an indication of the confidence level in response to the signal.

According to one aspect of the present disclosure, a system for identity authentication on a communication platform includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

According to another aspect of the present disclosure, a method for identity authentication on a communication platform includes communicating, via a first node to at least one second node, an identification, receiving, at the at least one second node, the identification, comparing the identification to authorized user data stored in a database storing the authorized user data, determining a confidence level for the first node, communicating a signal indicating the confidence level, and presenting at a user interface an indication of the confidence level in response to the signal.

According to yet another aspect of the present disclosure, a system for identity authentication on a conferencing platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication on an email communication platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a functional block diagram of an authentication system constructed according to one aspect of the present disclosure;

FIG. 2 is a process diagram of an authentication system constructed according to one aspect of the present disclosure;

FIG. 3 is a functional block diagram demonstrating one example of post-quantum secure authentication for a conferencing application utilizing spectrographic verification;

FIG. 4 is an exemplary interface of video conferencing software employing an authentication system; and

FIG. 5 is a flowchart demonstrating classification of an exemplary node as trusted or non-trusted using an authentication system constructed according to one aspect of the present disclosure;

FIG. 6 is an email interface incorporating a post-quantum secure authentication system according to one aspect of the present disclosure;

FIG. 7 is a flowchart of one post-quantum secure authentication method performed by an authentication system;

FIG. 8 is a functional block diagram of an authentication system constructed according to one aspect of the present disclosure;

FIG. 9 is a functional block diagram of an authentication system constructed according to one aspect of the present disclosure;

FIG. 10 is a functional block diagram of an authentication system constructed according to one aspect of the present disclosure;

FIG. 11 is an exemplary administrator portal demonstrating tracking the authentication of nodes of an authentication system;

FIG. 12 is an exemplary administrator portal demonstrating a virtual marketplace for third party verification services;

FIG. 13 is a functional block diagram of an authentication system constructed according to one aspect of the present disclosure;

FIG. 14 is a functional block diagram of an authentication system constructed according to one aspect of the present disclosure; and

FIG. 15 is a flowchart of a method for authentication performed by an authentication system.

The components in the figures are not necessarily to scale, emphasis instead being placed upon illustrating the principles described herein.

### DETAILED DESCRIPTION

The present illustrated embodiments reside primarily in combinations of method steps and apparatus components related to authentication. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

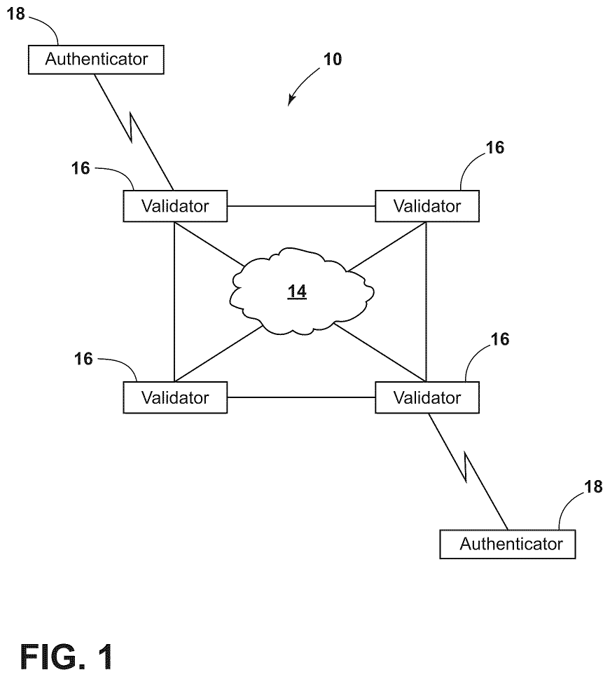

Referring generally to FIGS. 1-7, reference numeral 10 generally designates a system for identity authentication on a communication platform. The authentication system 10 carries out various processes for authentication of nodes on a network utilizing the communication platform. The system 10 thereby provides for enhanced security features that limit the success of attacks by quantum computing devices that use quantum mechanics to perform certain types of calculations more efficiently than classical computers. The system 10 and processes further provide for an unobtrusive and convenient notification mechanism to communicate indications of the authentication of users. The system 10 further provides enhanced validation of the authentication via blockchain technology. The system 10 and methods described herein can be configured for any application or website to provide a certificate authority for a plurality of uses. Further, the authentication system 10 can serve as a non-repudiation aggregator to detect and identify deepfake attacks. The authentication system can integrate into communication systems (e.g., business communication systems) to provide a visual indication of the threat.

With continued reference to FIGS. 1-15, according to one aspect, the system 10 for identity authentication on a communication platform includes a database 12 configured to store authorized user data. The system 10 further includes a first node that creates an identification and is configured to communicate the identification. At least one second node is configured to receive the identification, compare the identification to the authorized user data, determine a confidence level for the first node, and communicate a signal indicating the confidence level. A user interface 42 is configured to present an indication of the confidence level in response to the signal. The at least one second node can include a single node or a plurality of second nodes, such that the processes performed by the at least one second node can be distributed across several nodes. The database 12 can be remote or local (e.g., on a smartphone or local computer).

In general, computing equipment on the authentication equipment can serve as one or more nodes. For example, smartphones, tablets, computers, etc. may communicate information in the authentication system 10 to prove, verify, and/or validate user information. By way of example, a first user 22 can run an authentication software on a smartphone and/or computer used by the user, and a second user 24 can do the same. During, or prior to, communication (e.g., email, audio, video) between the first user 22 and the second user 24, the authentication software can create secure tokens that are verified using audio data, video data, IP address information, or other stored information accessible on the authentication system 10.

By way of example, the first node and the at least one second node may each have dual-functionality, such that each of the first node and the second nodes are operable to both prove and verify other nodes of the authentication system 10. For example, each user can have an audio fingerprint, or passkey, or other secure tokens that are compared to stored tokens (e.g., authorized user data) on the database 12 to verify the identity of the user and/or validity of the user.

It is appreciated that the authentications created, proved, verified, and/or validated may be in-band or out-of-band relative to channels utilized by the communication platform. For example, social network profiles, IP addresses, device manufacturing identifiers, or other out-of-band information can be used to compare to the authorized user data. The authentication may also, or alternatively, employ multiple-factor authentication. The authentication can also, or alternatively employ out-of-band exchange of tokens that are not via the same communication channel employing Public Key Infrastructure (PKI). Audio signatures for users of the communication platform can be compared to voice information of users during or prior to a conference interaction (e.g., the start of a virtual meeting). By enabling in-band and out-of-band verification methods, the authentication system 10 can provide for multiple options of authentication methods and generate a confidence level depending on the level of authentication or the types of authentications utilized.

As will be described further in relation to foregoing figures, signature verification and data exchange can occur between validators 16 of the authentication system 10 and user devices. Once a user device/node is verified with valid signatures, data exchange can occur between the user devices and the validators 16. The data exchanges can include various types of identifying information, including location information, endpoint validation information, voice information, video information, or any other authentication factor described herein for validating a node. The data exchange can be checked by the validators 16 by comparing the information to secured user information sourced internally or externally. For example, and as will be described further herein, the validators 16 can be in communication with third-party expert services that provide additional or auxiliary verification of credentials from the user device. Thus, the system 10 can interact with other validation systems (e.g., software applications) that are designed to detect deepfakes of one or more particular parameters (e.g., voice, location, call history) that the third-party service is an expert in.

It will also be appreciated that, while configured to employ blockchain validation, the validators 16 can additionally or alternatively include other forms of validation, including Ethereum name service (ENS), decentralized identity (DID) systems, verifiable data structures, claimant models, certificate transparency or any other verifying service.

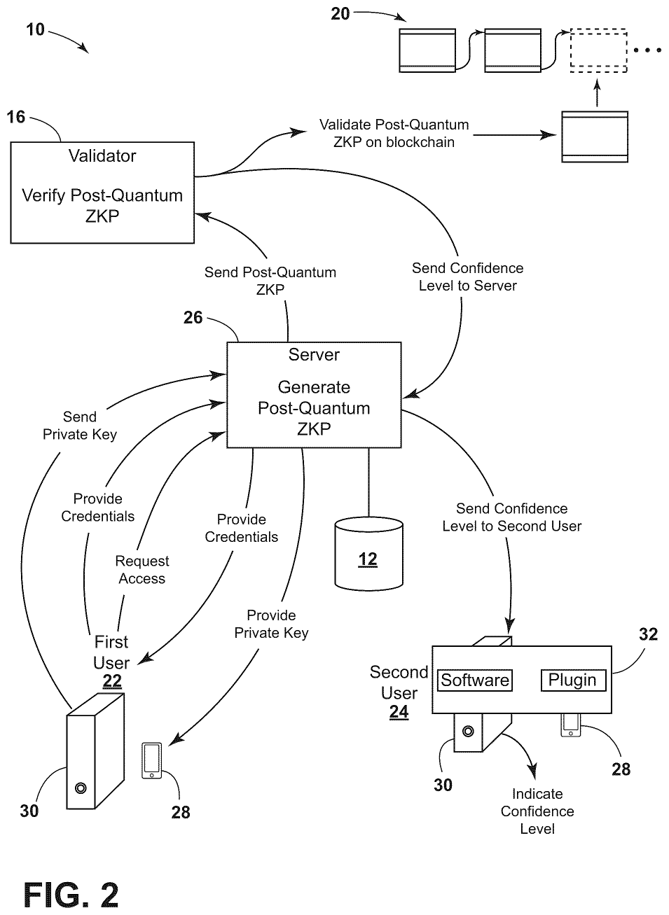

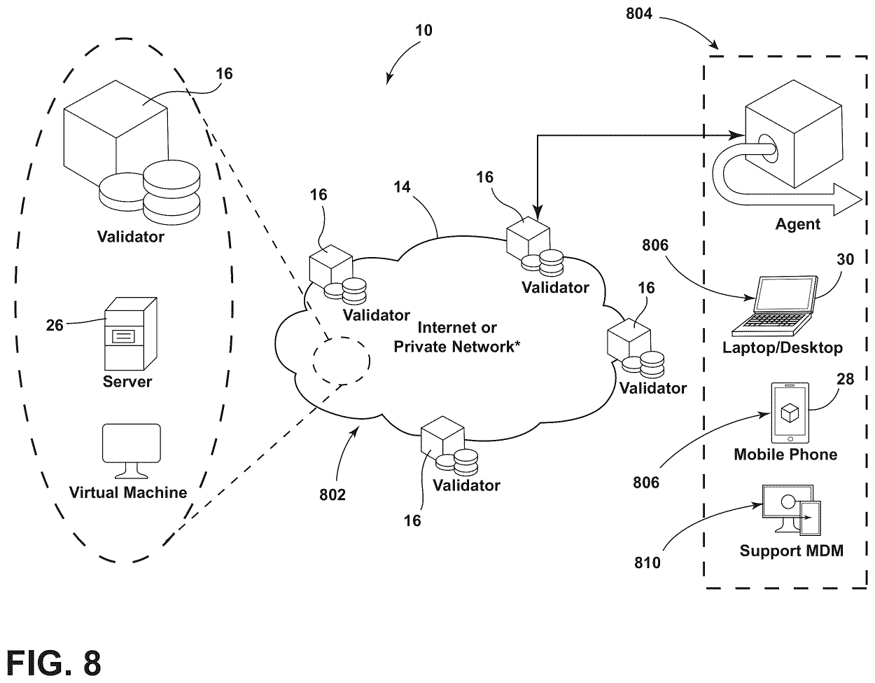

With particular reference to FIG. 1, the authentication system 10 includes a network 14 of validators 16 that interact with one or more authenticators 18. The authenticators 18 may include authentication software, such as a plug-in (client) for host software operated on a computing device, that interacts with one or more features of the host software. By way of example, the host software may be an email application/platform, a conferencing software (e.g., video conferencing software, audio conferencing software), or another communication software that is configured to accept the authentication client. For example, an application programmer interface (API) can be provided for video conferencing software to allow data exchange and programming of additional features. Accordingly, the authenticator(s) 18 may be installed in a node, such as a mobile device 28 or a computer 30, and generate a post-quantum secure proof. The post-quantum secure proof is communicated to one or more of the validators 16 or devices (e.g., mobile devices 28/computers 30), which verify the proof. The validators 16 are further configured to validate the proof/authentication by participating in a blockchain 20, described further below in reference to FIG. 2. Another example of how the validators 16 are implemented in the system 10 is presented further in reference to FIGS. 8-12.

The authentication can be accomplished via a zero-knowledge proof (ZKP) created by the authenticator 18. The ZKP can incorporate a PKI in some examples. A ZKP proof is a mechanism of demonstrating that one party knows a piece of information without revealing what the information is. Authentication using ZKPs is a convenient way for one party (called the prover) to prove to another party (called the verifier) that the party is who the party purports to be without sharing any information about the party. This is achieved by performing a series of mathematical computations that allow the prover to convince the verifier of the truth without disclosing the underlying data or secret.

The ZKP employed by the system 10 utilizes post-quantum secure mathematical models to generate the proof. For example, the ZKP can utilize lattice-based cryptography with difficult lattice problems, such as Learning with Errors (LWE) problems involving finding a hidden vector given noisy linear equations. In some examples, the ZKP utilizes one or more other quantum-resistant modeling techniques, such as Merckle signatures and McEliece cryptosystems. In general, the ZKP utilized by the authentication system 10 is post-quantum secure to limit or negate attacks by quantum computing systems that utilize qubits to break classical cryptographic algorithms.

In one example, the post-quantum secure authentication technique employs a polynomial commitment scheme. In this example, the prover (e.g., the committer) commits to a polynomial without revealing its coefficients. The commitment serves as a way to publicly demonstrate a commitment to a specific polynomial while keeping the details of the polynomial secret. For example, coefficients of the polynomial can be hidden, and such coefficients can be secret to the verifier, such that, without them, the messages are difficult to decrypt via quantum computing or classical computing.

In some examples, the ZKP is a Zero-Knowledge Scalable Transparent Argument of Knowledge (ZK-STARKs). A ZK-STARK is designed to be highly efficient and scalable to handle large amounts of data quickly and effectively. ZK-STARKs offer scalability, meaning that the size of the proof remains constant even as the complexity of the statement being proven increases. Further, ZK-STARKs provide for computations off of the blockchain 20, such as on a mobile device 28 or a computer 30 for a user of an authentication application, thereby providing for efficient data processing. The scalability is achieved through advanced mathematical techniques, including the use of error-correcting codes, polynomial commitment schemes, and algebraic geometry. ZK-STARKs are characterized by their transparency, allowing anyone to publicly verify the validity of a proof without relying on trust in a central authority. Applications of ZK-STARKs extend to various domains, including blockchain 20 technology, where they enhance privacy, transparency, and efficiency. By leveraging the principles of zero-knowledge cryptography, ZK-STARKs contribute to the development of secure and privacy-preserving systems in the digital age.

ZK-STARKs have applications in various areas, such as blockchain 20 and cryptocurrencies, where they can be used to enhance privacy, security, and efficiency. For example, they can be used to verify transactions and smart contracts without revealing sensitive information about the parties involved or the actual details of the transaction. More importantly, ZK-STARKs are considered to be effective against quantum computing due to their underlying cryptographic properties. Quantum computing is a type of computing that uses quantum-mechanical phenomena to perform computations. It has the potential to solve certain complex problems much faster than classical computers, which could have implications for traditional cryptographic systems used to secure data and transactions. One of the key cryptographic properties that make zero-knowledge proofs, including Stark, resilient against quantum computing is via the use of “trapdoor functions” or “one-way functions.” These are mathematical functions that are easy to compute in one direction but difficult to reverse (compute in the opposite direction) without knowing some secret information called the trapdoor or private key. Zero-knowledge proofs use these trapdoor functions in a way that allows the prover to generate a proof without revealing the secret information (trapdoor). In a quantum computing scenario, if an adversary tries to use quantum algorithms to reverse the trapdoor function and break the proof, it would still face significant challenges due to the difficulty of reversing these one-way functions. Therefore, ZK-STARKs are designed to be post-quantum secure.

Stark zero-knowledge proofs have several key advantages over other PKI types:
Zero-knowledge—The prover does not reveal any information about the secret or the process used to prove it, other than the fact that they know the secret and the truth that they are who they say they are;
Transparency—Proofs generated are easy to verify, meaning the verifier can quickly confirm the validity of the proof; and
Scalability—Stark is designed to handle complex computations and large amounts of data efficiently, making it suitable for real-world applications such as deep fake detection.

Referring now to FIG. 2, an exemplary process is demonstrated in reference to two users 22, 24, with a first user 22 verifying identity using one or more ZKPs and multifactor authentication, and a second user 24 receiving a confidence level as to the authenticity of the first user 22. In the present example, the first user 22 requests access to some aspect of the communication platform (e.g., access to a virtual meeting). The request is processed by a server 26, which responds with a request for credentials. The first user 22 responds with credentials, such as a login or password that can be encrypted with one or more post-quantum secure keys. Using multi-factor authentication, the server 26 responds with a request for entry of a private key. Although demonstrated as an out-of-band request (e.g., to a mobile device 28 of the first user 22), it is contemplated that the private key request could be in-band (e.g., using the same communication channel as the credential communications). In effect, the communication of the private key can be encrypted or otherwise secure, such that the response by the first user 22 with the private key is post-quantum secure (e.g., including a zero-knowledge proof of the same).

The multi-factor authentication demonstrated in FIG. 2 is merely exemplary and non-limiting. For example, while an alphanumeric code may be communicated to the mobile device 28 for entry into the computer 30 of the first user 22, other authentication methods can be employed. For example, the credentials and/or the private key could be a voice message of particular words or phrases that the first user 22 records or streams, with the private key being a request from the server 26 to the first user 22 rather than providing the private key. In either example, a post-quantum secure proof is provided by the prover (the first user 22).

The server 26, while demonstrated as a separate module, may be common to the validator 16 and communicate verification and validation requests to the validator 16 to confirm the authenticity of the ZKP and verify. The validator 16 then verifies the ZKP by comparing the ZKP to authorized user data. For example, using PKI, the validator 16 can verify the proof by solving the ZKP with existing pre-stored user information stored in a database 12 accessible only by a certified authority. In this way, the validators 16 may operate as a certificate authority for and issue digital certificates under a PKI model using key pair generation. Most notably, such certificates can be post-quantum secure using ZK-STARKS. In addition to verification, the validators 16 are further configured to validate the ZKP on a blockchain 20 that utilizes consensus mechanisms to validate transactions (e.g., user authentication).

While any given authentication method (e.g., mode of providing and/or verifying the ZKPs) may operate as a binary, yes/no authentication, because multiple data streams can be utilized to verify identity, an overall confidence level, or score, can be generated by the authentication system 10 and communicated to other users regarding the authenticity of the first user 22. For example, while a geo-locating verification may place the first user 22 in Canada, the first user 22's LinkedIn® page may indicate a work or home location of Japan (thereby not meeting a verification). However, the audio signature of the first user 22 may be a match. In this case, different data streams may be weighted more heavily than others. Accordingly, the authentication system 10 can amalgamate the verification modes and generate a confidence level that the purported user is, in fact, the first user 22. The processing of different verifications may be executed on the server 26, another server, the individual end nodes (e.g., mobile device 28 or computers 30 of the users), the validators 16, or any other control device of the authentication system 10.

With continued reference to FIG. 2, the confidence level is communicated to the exemplary second user 24. The authentication app (e.g., plugin 32) running on the computer 30 of the second user 24 processes the confidence level and interacts with the host software to indicate the confidence level in real-time. Other information may be provided, such as the location of the first user 22 or what verifications have been successful. For example, check-boxes or red X's indicating “IP Address match,” “Location Match,” “Audio match,” “Voice Match,” “Image match,” or the like may be displayed. Further, verification scores (e.g., percentage of confidence) can be displayed for each verification. In this way, the authentication system 10 can provide for limited obtrusiveness for user interaction.

Referring generally to FIGS. 1 and 2, the system 10 can be configured for redundancy and be highly scalable. For example, the network 14 of validators 16 can be communicatively coupled with the blockchain 20, such that any validator 16 on the network 14 can verify and/or validate the post-quantum secure identification(s). For example, the blockchain 20 allows the system 10 to handle an increasing number of authentications and/or participants while maintaining consistent or reduced latency. For example, the blockchain 20 can implement a consensus mechanism such as a proof-of-work or proof-of-stake that can enhance scalability by reducing resource requirements for consensus. The system 10 (e.g., dividing the blockchain 20 into smaller parts) can be implemented to allow multiple authentication transactions to occur simultaneously across a plurality of shards. In some examples, the validators 16 can perform off-chain authentication verifications that further provide scalability to the system 10. The network 14 may also be configured to accept new or additional validators 16 to provide scalability. The system 10 can provide for redundancy such that, in the event that one validator 16 is rendered inoperable, or simply fails to verify a proof prior to another validator 16, other validators 16 on the network 14 can perform the validation/verification.

In one aspect, the system 10 is provided with federating capabilities. For example, the system 10 can include a federated identity provider, such as a server (e.g., server 26), that has an internal ID provider (e.g., for devices on a private local area network (LAN)) and an external ID provider (e.g., for devices on a public network (Internet)). The federated identity provider can therefore differentiate between internal and external users/devices. In some examples, the federating functionality allows the system 10 to manage user credential verifications based on classification of the given user. For example, a user accessing the system 10 via a first domain can require a first level or type of credentials, and a user accessing the system 10 via a second domain can require a second level or type of credentials. The federated functionality of the system 10 also allows the system 10 to operate with other trusted domains (e.g., some public domains). Accordingly, the level or type of credentials required can be dependent on the domain, such that access via a public network may require a different credential verification than access via a private network.

By way of example—three users attempt to communicate on a communication platform. A first user and a second user are on a private network local to or managed by the system 10 (i.e., “private users”), and a third user accesses the communication platform via a public domain. This example may be similar to a case in which the first and second users are of a common organization, and the third user is outside of the organization. In these examples, the verification required for the third user may be more strict than the verifications required for the first and second users via implementation of the federated identity provider. Accordingly, the third user may be required to provide the post-quantum secure identification (or post-quantum resistant identification) to access the communication platform, whereas the first and second users have a different level (e.g., lower level) of verification needed by the system 10. In this way, the ZKPs may only be required for some users (e.g., external users or users having historically low confidence levels). Continuing with this example, the confidence levels may only be presented on-screen for some users (e.g., the users on the private domain), whereas the third user may not have access to the confidence level(s). Thus, the federated functionality can work “one-way” from the perspective of one or more nodes. In this way, the system 10 can be dynamic to selectively allow access to the verification information before, during, or after a communication (e.g., during a virtual meeting).

In another example, the first and second users are part of a common domain (e.g., a common organization), and the system 10 federates nodes of the common organization based on security levels assigned to the users. For example, the federation can selectively limit communication of the confidence level based on the comparison of identifications of the user to the authorized user data. Thus, when performing a database dip, the system 10 can check what requirements are needed for individual users. The selective limiting of communicating the identification can be partial or complete. By way of example, the system 10 can present a confidence level of other users during a conference to the first user while simultaneously limiting presentation of the first user to the other users. For example, the one or more of the second nodes (e.g., the server 26, a user device, or another node) can be configured to determine a security level corresponding to the identification based on the comparison of the identification to the authorized user data. In this way, information regarding the security level of the communication can be limited to some users and not other users.

As an example, different federations could be from different entities/organizations or within a single organization for the purpose of separate employee security levels. The sharing of identity information could be as simple as sharing only the confidence level (e.g., a confidence score), limiting the communication to unidirectional confidence detail (e.g., one or more users having access to the security levels of other users), limited bidirectional communication, or completely unhindered confidence detail. In one example, the system 10 is configured to provide a decentralized identity via sharing the confidence level and detail with a different set of federated nodes.

The system 10 can also include an artificial intelligence (AI) engine configured to train at least one machine learning model using past authentications. The AI engine can reside on any node of the system, such as on the server 26, and be configured to train one or more of the machine learning models to determine confidence levels for identifications. For example, the AI engine can use past successful or failed authentications to weigh one or more authentication factors, or credentials, more or less than others. By way of example, if past identities were authenticated based primarily on IP address verification or audio verification, then determined later (e.g., during a conference call) to be a deepfake based on image-based verification, the system 10 can adjust to weight image-based verification higher than IP address verification or audio verification. This example is non-limiting, as the models may update consistently to determine reliable and quick authentication methods. For example, the system 10 can have a plurality of models that are trained for given user sets (e.g., users having a first security requirement compared to other user sets), individual user identities, given authentication methods, or any combination thereof. The data collected and stored in the database 12 or another memory can therefore include historical information related to successful verification methods for specific identities, sets of classified identities (e.g., users with a first security clearance level, users with a second security clearance level, etc.), or specific combinations of authentication (e.g., geolocation and IP address verification, audio and visual, audio and geolocation, etc.).

In general, the system 10 can utilize registration to a centralized or cloud database or on-prem database for subscription payment, audit logs, backup of key pairs (if permitted by corporate/government policy), and search functions. The communication could be peer-to-peer (e.g., endpoint to endpoint). Since authentication tokens are relatively small, ranging from a few thousand bytes to a few hundred thousand bytes, thousands of contacts can be stored on a current mobile phone or laptop without consuming a significant amount of storage. This database 12 (on the user device) can be a blockchain 20 where authentication may include the time, date, name, and/or location. The device can be added to the blockchain 20 and available to allow for unaltered forensic accounting. Furthermore, the blockchain 20 can store the data on the cloud (as a series of publicly available servers) that can be accessed anywhere or the blockchain 20 can employ sharding to adhere to a security policy that requires on-premises functionality (or only organizational control with no internet access) that may exist on a private computer or series of computers, virtual machines or app containers. This method will serve organizations with an extremely high level of security requirements.

The system 10 and methods herein can also be applied to backup data and audit/logs that can otherwise be compromised or accessed. In environments that require the highest levels of required security, the database 12 could be placed on one or more virtual machines or containers instead of being in the cloud (internet). A container is a standard unit of software that packages up code and all its dependencies, so the application runs quickly and reliably from one computing environment to another.

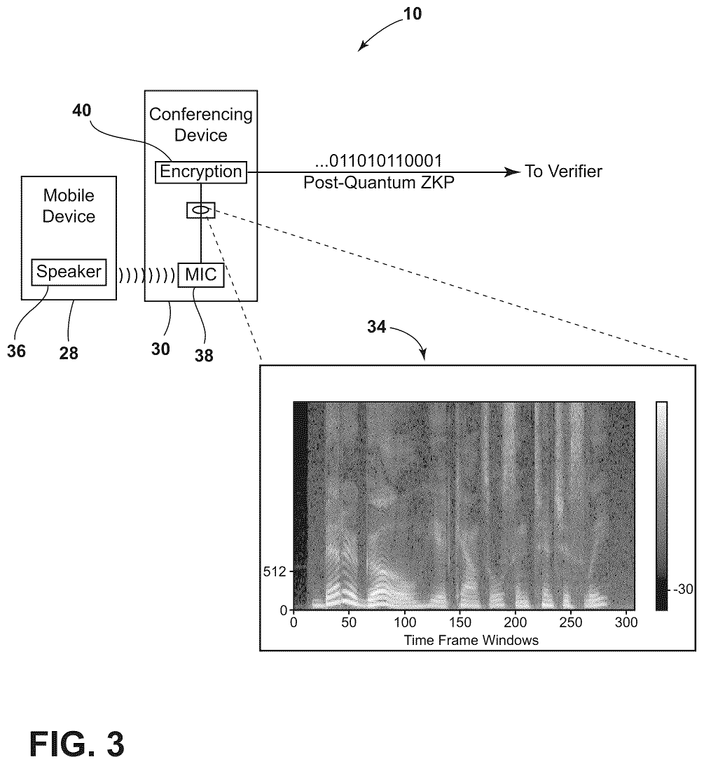

Referring now to FIG. 3, one arrangement for providing post-quantum secure authentication is demonstrated using audio signature verification for the user. In this example, the authenticator 18 records or streams audio data, represented in the form of an audio spectrogram 34. The audio spectrogram 34 is a visual representation of audio that can be provided via a frequency transformation to isolate frequencies of voice or tones for comparison. The frequencies can be compared to the authorized user data in the form of frequencies from voice recordings or pre-defined frequencies. In the present example, a predefined frequency is communicated (e.g., a private key) to the mobile device 28 of the user. The mobile device 28 includes a speaker 36 that outputs the audio. A microphone 38 of a conferencing device 30 (e.g., the computer) of the user receives the audio, which is read by the authenticator client installed on the conferencing device. A post-quantum ZKP is created, encrypted via an encryption module 40, and communicated to the verifier (e.g., the validators 16 and/or server 26). The authentication system 10 can be configured to decrypt the message using post-quantum decryption via access to the authorized user data (e.g., the tone communicated to the mobile device 28) to confirm that the tone sent is the same tone returned. In this way, a post-quantum secure authentication can be verified using audio data.

It is contemplated that the authenticator 18 can sample the data periodically to continuously verify the user. Additionally, or alternatively, the audio information may be captured or streamed prior to initiation of a conference call. The audio can include distinct tones or voice audio. For example, because voices tend to be distinct or carry a personalized cadence, vocal range, or other audio quality for individual people, the unobtrusive sampling of voice data to confirm user identity can be employed for post-quantum secure authentication. As previously stated, different verification modes can be employed in tandem with this verification mode or other verification modes to produce an accurate confidence level. It is also contemplated that the arrangement of the microphone 38 and the speaker 36 for the user may be modified to utilize the microphone 38 of another user, such that audio emitted by the speaker 36 of one user device can be detected by a microphone 38 remote from the user being verified.

Still referring to FIG. 3, in the example of tone generation and reading from the mobile device 28 of the conferencing device itself, the audio signals may be within hearing range or outside of hearing range. For example, the audio signals may be outside of the range of about 20 Hz to 20 kHz. For example, high-frequency audio may be output by the speaker 36 (e.g., above 20 kHz). In some cases, the high frequency is under 20 kHz (e.g., 15 kHz or higher). The audio tones may also be varied over time to limit the options of recording pre-communicated tones to spoof verification. By providing high-frequency audio signal verification, the conference is not disturbed, and authentication can take place in an unobtrusive way.

The methodology of spectrogram 34 authentication can hereby aid in deep-fake detection. For example, the system 10 can capture a brief sample of audio and compare the sample to information in one or more databases 12. This audio fingerprint can be used to confirm the audio and/or video stream matches the scheduled meeting contacts. The audio spectrogram 34 can be used as a method of key exchange that is in-band, such as part of the audio and/or video stream. Furthermore, either the in-band or out-of-band methodologies of key exchange and deep fake detection can manage a plurality of participants that could be verified in the first moments of a streaming session or asynchronously if reviewing static files.

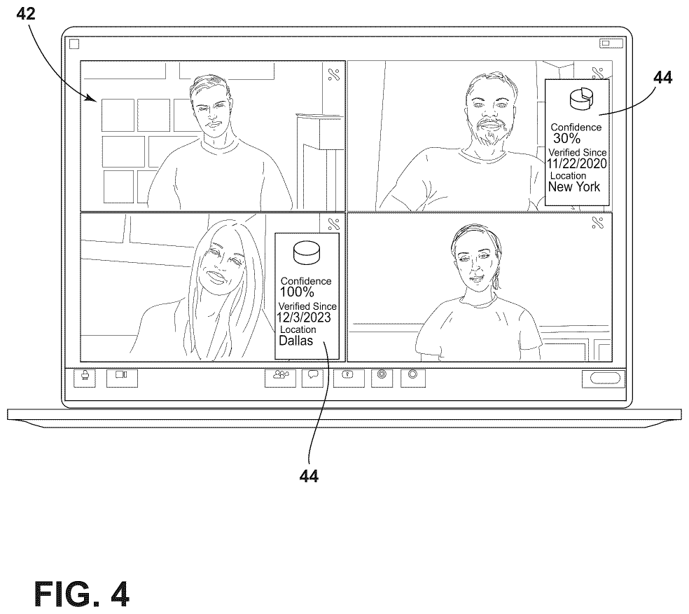

Referring now to FIG. 4, the post-quantum secure authentication is demonstrated via a user interface 42 configured to present an indication of the confidence level in response to verification(s) from the authentication system 10. As demonstrated, during a video conferencing session, the authentication plugin 32 can communicate with the video conferencing software to indicate authentication information to a target user (e.g., a user using the user interface 42). The indication is presented visually, though the indication could also or alternatively be audible. In the present example, a graphic 44 demonstrating the likelihood of authenticity via a pie chart, via numerical percentage, and/or via other authentication factors (e.g., location, date of last verification) is presented. The particular graphic 44 overlaying the video stream is exemplary and non-limiting. For example, flashing indicators, color changes, forced dropped connections, text boxes (e.g., “Warning,” “Alert”), or other visual or audible indications may be presented to indicate the authenticity of the users. Thus, the confidence level can be representative of user authentication for users of the conferencing software.

The key exchanges previously described with respect to FIGS. 2 and 3 can take place concurrently during streaming of the conference call depicted in FIG. 4. For example, each user's computer 30 may be configured to output an audio tone that is recorded by the multi-factor device (e.g., mobile device 28) of each user. In the present example, because one participant is likely not authenticated and potentially a deep-fake, the audio tone may not be output correctly or at all. In the example of audio fingerprint, the suspected user's voice can be unverified, while other aspects (social media accounts, location, IP address, device manufacturer, operating system version/type) are correct. In this case, the authentication system 10 assigns a low confidence level (30%), as the system 10 may weight audio verification more heavily than aspects that can be spoofed more easily. This example is exemplary and non-limiting, such that audio may be weighted less than other verification methods in some examples.

Still referring to FIG. 4, the post-quantum secure identification can include video communication via the conferencing software for key exchange. For example, video data representative of each user of the conferencing software may be processed by an image processor or a video processor to match users with the authorized user data stored in the database 12. For example, facial recognition, relative body dimensions, or any other image-based identification techniques employed by identity verification can be employed as the key exchange. In this way, the verifier can verify the video data representing the user via comparison of the post-quantum secure identification to the authorized user data. The video/image matching can be an addition or alternative to any of the authentication parameters previously described.

Once a node is suspected of being a deep-fake, a method of tracking the participant is presented to the user. One example is a process where a service such as Zoom®, Google Meet®, or Microsoft Teams® presents an API to expose certain details of a video conference. Many services have open APIs to allow basic call details such as username, source IP addresses (since many are direct, peer-to-peer communication such as WebRTC), and potentially even the MAC address in some situations. Taking this information and running a SWIP on an IP address, the system 10 can determine who is the owner of said IP addresses and what part of the world they are from. Additionally, a port scan can be executed on the IP address to determine a digital “fingerprint” which could include the make and model of the device, operating system, version, and the services running on said device to allow for even further forensic investigation.

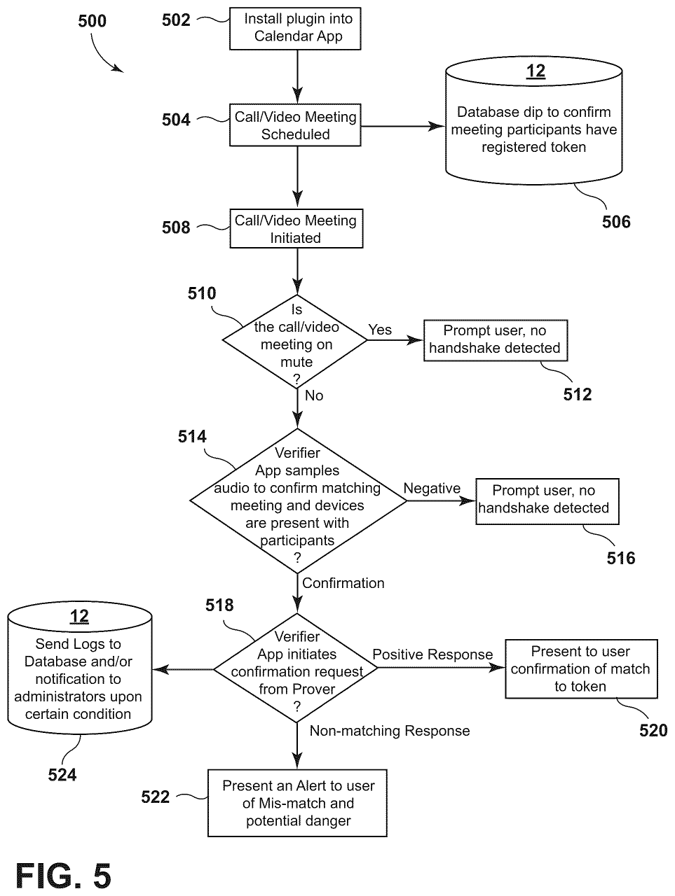

Referring now to FIG. 5, a process 500 of authentication for conferencing software includes installing a plugin 32 to host software, such as a calendar application, at step 502. The plugin 32 can include one or more parts of the authenticator 18, such as ZKP algorithms, mechanisms for creating private keys, or the like. At step 504, the conference with users for verification is scheduled. At step 506, the authenticators 18 for each user are confirmed by the authentication system 10 as having registered tokens for future verification. Once the conference is initiated at step 508, and the software checks for audio entablement (speaker 36/microphone 38) at step 510. If no audio detection mechanisms are detected, the user is prompted to enable audio detection at step 512.

When audio detection is enabled, the verifier application samples audio to confirm matching meetings and devices are present with participants at step 514. For example, the verifier may be installed on another node (another user's device). In some examples, the verifier is installed on a secondary device (e.g., a mobile device 28) that can operate as the prover by outputting a specific audio tone, and a primary device (a user computer 30) can record the audio tone and verify. In this way, a client can be installed on a smartphone of a given user and a computer 30 of the given user. In the present example, the prover can be installed on one node for a first user 22 and the verifier can be installed on a second node for a second user 24.

If the audio cannot be confirmed, the user is prompted to adjust audio settings or otherwise confirm identity before proceeding at step 516. Alternatively, participants can receive an option to accept the unauthenticated user, for example. If the audio is confirmed, the verifier application initiates a confirmation request from the prover at step 518. For example, a secure key exchange using Diffie-Hellman or other digital signal confirmation to confirm tokens can be employed (step 520). If a mismatch is detected, the verifiers are notified (e.g., a low confidence level or another metric is displayed, the user is booted) at step 522, and logs of the conference are saved to one or more databases 12 at step 524. These logs may be communicated to administrators of the authentication system 10 depending on the severity of the breach or attempted breach.

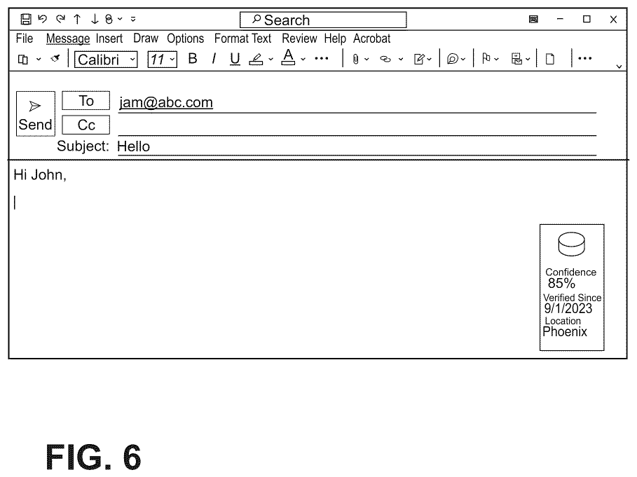

Referring briefly to FIG. 6, the post-quantum secure identification can be utilized in an email communication software/platform. By way of example, the graphic 44 used for conferencing in FIG. 5 can be used in a similar manner. It is contemplated that this indication can be presented in various ways, as previously described. In this example, the indication(s) can be presented in a ribbon or another part of the email object. For example, the graphic 44 could appear near the recipient address when the target user enters a recipient email address. Upon entering the email address, the authentication system 10 can operate as a certificate authority as previously described, with the graphic 44 being presented in the digital object. Accordingly, the plugin 32 can be a software add-in to a variety of communication platforms.

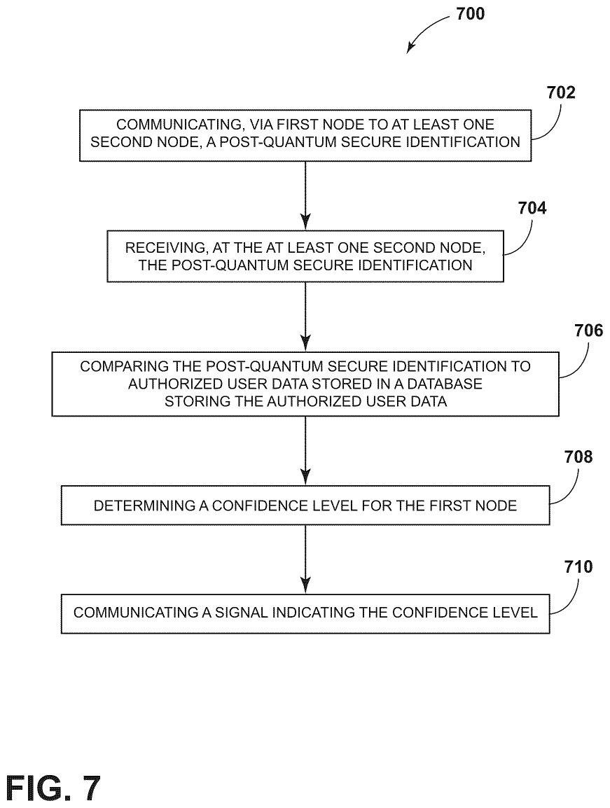

Referring now to FIG. 7, an exemplary method 700 carried out by the authentication system 10 includes communicating, via a first node to at least one-second node, a post-quantum secure identification at step 702. At step 704, the method 700 includes receiving, at the at least one second node, the post-quantum secure identification. The method 700 further includes step 706 for comparing the post-quantum secure identification to authorized user data stored in a database 12 storing the authorized user data. At step 708, the authentication system 10 determines a confidence level for the first node. At step 710, the method includes communicating a signal indicating the confidence level. In some examples, the method 700 includes presenting, at the user interface 42, an indication of the confidence level. The method 700 can be modified to include any of the steps previously described as performed by the authentication system 10.

Methods and systems consistent with the present invention solve the inherent trust problems with existing voice and video conferencing systems. The method of convenient verification of trusted parties that can be post-quantum secure adds to many of today's commonly used methods of 2-factor authentication, Public Key Infrastructure (PKI), Internet Protocol Security (IPSEC), Digital Certificates and Certificate Authorities (CA), and dramatically increases the security during real-time or asynchronous playback.

What is proposed is a method of authenticating trusted parties and detecting deep fakes in an unobtrusive way. One example would be to create a secure token that has a public key that can be shared freely. By using open application programmer interfaces of calendar tools, participants can be automatically identified and matched up to new or previously exchanged credentials using both internet data communication and/or in-band audio transmission of the session to authenticate the individuals on the call or in the conference. By using these same calendar tools (that are part of office suites) the contacts who transmit audio and video images via email, FTP, or cloud storage can be matched with their authentication tokens.

According to some aspects, the system 10 and methods described herein can require users to enter employee IDs or government-issued IDs and information into the system 10 through a series of images. This verification can be done on a large scale via companies entering employee data, or this can be done on a personal level. Social profiles of employees can be linked to the verification as well. Verification can be strengthened (e.g., greater confidence levels) based on consistent interaction among verified users. Inconsistent interactions (e.g., days or years between meetings with verified users) can result in a reduced confidence level. VPN tunnels can also be detected by the system 10.

Referring now to FIGS. 8-15, the system 10 can provide for enhanced authentication by allowing third-party authentication services to operate within the system 10. For example, the system 10 can be implemented as a platform to amalgamate verification information from third parties and from the validators 16 themselves. As will be described in the foregoing figures, the system provides the third-party access via a marketplace whereby services of the local to the authentication system 10 (e.g., the validators 16) and the services of various third parties can be selected to use focused, detailed elements to improve the confidence value generated by the system.

One example of a service that can be provided by the system 10 includes at least one immutable database with immutable reporting. Because the system 10 can use blockchain technology to validate signatures to verify identity, immutable reporting could be utilized by the blockchain to create an unalterable ledger. Depending on the blockchain that is selected, the system 10 could incur fees. Due to the fees charged for various third-party operability with the system 10, a virtual marketplace can be provided to an administrator that allows selection from a plurality of these third-party services. Each third-party service can have a monetary cost or subscription fee. Upon selection of any of the third-party services, the devices assigned to participants (e.g., users) of the system can be updated to include the third-party services. The third-party services can be operated independently, though, as will be described, are configured to mesh with the infrastructure of the validators 16 to enhance estimation or determination of the confidence level for each user or device.

With continued reference to FIGS. 8-15, the system 10 can include a validation system 802 (e.g. one or more of the validators 16) and one or more agents 804 communicatively coupled with the validation system 802. For example, the one or more agents 804 can be installed on one or more user devices 806 (e.g., mobile device 28, user computer 30). The agent 804 is configured to communicate a first credential indicating an identification to the validation system 802. For example, the agent 804 can be software running on the user device 806 and communicating with software of the validation system 802. The agent is also configured to communicate a second credential indicating the identification to a verification service 808, such as a third-party verification service. The validation system 802 includes a database 12 configured to store authorized user data. The validation system 802 can also include a portal configured to provide selection of the verification service 808 from a plurality of verification services 808. The validation system 802 is configured to compare the first credential to authorized user data. For example, the authorized user data can be stored in the database 12. The validation system 802 is further configured to determine a confidence level of validity of the identification based on the comparison of the first credential to the authorized user data, receive a verification of the second credential from the verification service 808, and modify the confidence value based on the verification.

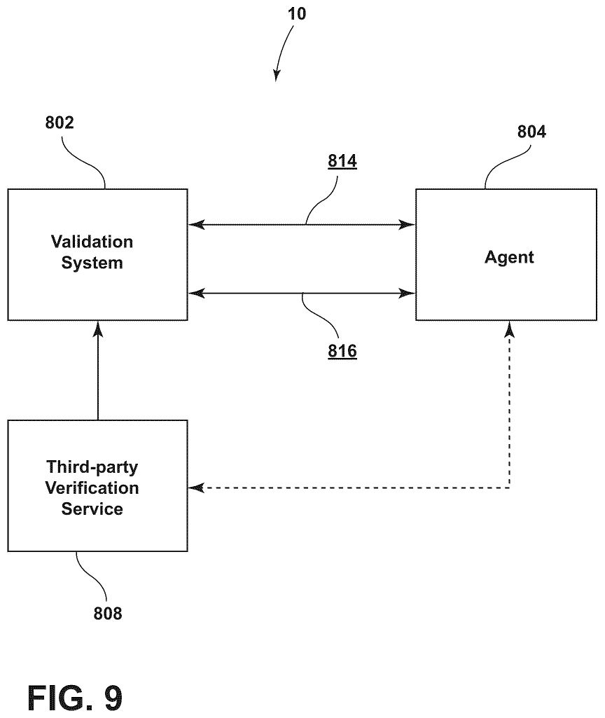

Referring more particularly to FIGS. 8 and 9, the system 10 is demonstrated in simplified forms utilizing the validation system 802 including the network 14 of validators 16. In this example, the nodes for users are demonstrated as agents 804 installed on the user devices 806. It is contemplated that the agent 804 can be installed and/or accessed via a mobile device management (MDM) system 810 that allows for administration of mobile devices. For example, a client authenticator application can be installed on a smartphone or tablet and managed via the MDM system 810. The validation system 802 can incorporate the server 26, validators 16, one or more virtual machines, and blockchain services previously shown and described with respect to FIG. 2.

With reference to FIG. 3, the validation system 802 and the agent 804 can communicate via a signature service 814 and a data service 816. For example, the validation system 802 can issue certificates to and/or verify signatures for the agent initially and/or periodically via the signature service 814. In some examples, the validation system 802 can send a token to the agent 804 that can be refreshed periodically and/or revoked in the event of a compromised agent 804. This can allow authentication of the agent 804 without having to send private keys. For example, a token can be issued monthly, semi-annually, weekly, daily, hourly, or any other periodic frequency. The token can be revoked, for example, upon detection of aberrant software or significant data exchange oddities (e.g., failed verifications or the like) during use of the data service 816. Following proper certification via the signature service 814, the data service 816 provides a stream of data from the agent 804 to the validation system 802 including the identification information previously described. For example, the first credential(s) can be communicated to the validation system 802 via the data service 816. The validation system 802 can then generate, or determine, a confidence value that the user associated with the agent 804 or the agent 804 is not compromised, as previously described with respect to the first and second nodes.

In addition to communication of the first credentials via the data service 816, the system 10 can also include the verification service 808 provided via a third party. The verification service 808 can also be in communication with the agent for receiving second credentials and determining a verification of the second credentials. The verification is communicated to the validation system 802, which can modify the confidence value based on the verification. While determining the confidence value using the first credentials and subsequently adjusting the confidence value based on the verification is described herein, it is contemplated that these steps may be in parallel or simultaneously, such that a common function of the first and second credentials can be determined for weighting the first and second credentials.

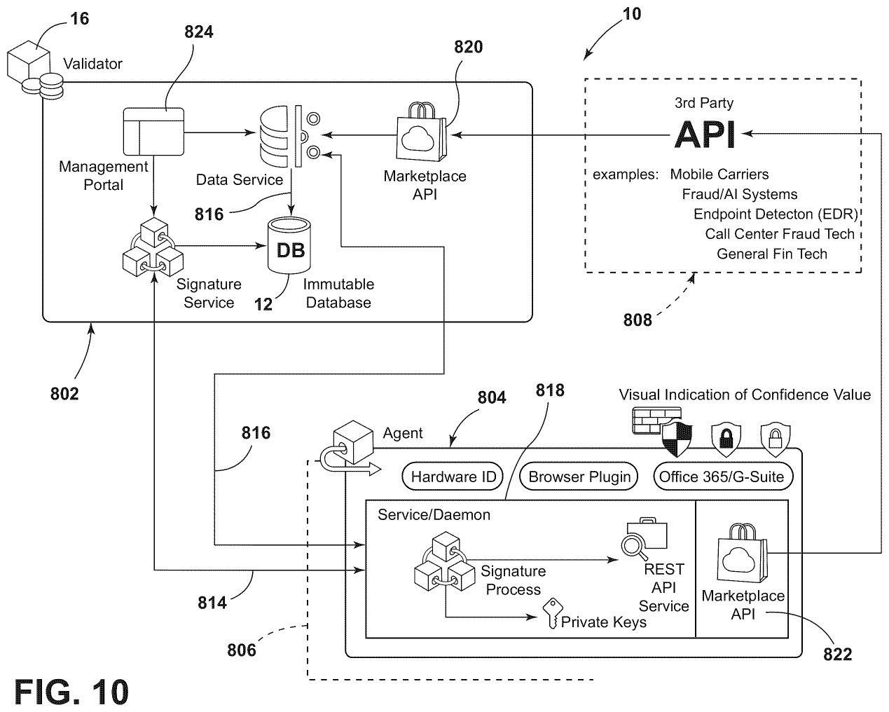

It is contemplated that the verification service 808 can include a server/client topology, with the client installed on the user device and the server being remote from, or separate from, the system 10. Accordingly, the agent 804 and the client of the third-party service 808 can be installed on the same device, and/or the validation system 802 can be on a different network than the verification service 808. The communication between the verification service 808, the agent 804, and the validation system 802 is further described below in reference to FIG. 10.

Referring now to FIG. 10, details of the system 10 are demonstrated in reference to an exemplary agent 804 having an authentication service 818 running on a user device 806. The service 818 can incorporate blockchain for secure key exchange (e.g., ZKP previously described) and signature verification. For example, the authentication service 818 can include/execute the signature process for communication with the validation system 802. Based on the verified signatures, the validation system 802 can issue a certificate (as a certificate authority, CA) to the user device 806. After the signatures for the agent 804 are validated by the signature service 814, the validation system 802 is configured to read identification information from the agent 804 via the data service 816. For example, for a validated user device 806, the validation system 802 monitors the first credentials from the agent 804 to determine the confidence level for display to other agents 804 supported by the system 10. For example, during a web conference or on an email application running on another agent 804 on the system 10, a user of the other agent 804 (e.g., a second node) can view an indicator, such as a color indicator, that indicates the validity status of a user of the exemplary agent 804 (see, at least, FIGS. 4 and 6).

To provide communication between applications on the nodes and between nodes, at least one application programming interface (API) 820, 822 communicatively couples the verification service 808 with the agent 804 and the validation system 802. For example, the at least one API 820, 822 can include a first API 820 at the validation system 802 and a second API 822 installed on a machine on which the agent is running (e.g., the user device 806). The second credentials can be communicated from the agent 804 to the verification service 808 via the second API 822 interfacing with the authentication service 818. For example, the at least one API 820, 822 can include representational state transfer (REST) architecture to control how the applications interface via the at least one API 820, 822. It is contemplated that other interfacing architecture can be utilized.

For example, the verification service 808 may be configured to communicate with the validation system 802 and/or the agent 804 via a software development kit (SDK) installed on the user device 806 and/or the validation system 802. For example, the SDK can be used for developing an application specific to interfacing with the plurality of verification services 808. In another example, the verification service 808 may be configured to interface with the agent 804 via a webhook that provides communication via the at least one API 820, 822. In some examples, the webhook is employed to allow the agent 804 to communicate the second credential(s) to the verification service 808.

With continued reference to FIG. 10 the database 12 can be configured as an immutable database that provides for append-only tracking and/or transparency. Accordingly, the immutable database can be tamper resistant and utilize cryptographic signatures and/or Merkle Directed Acyclic Graphs (DAGs) to limit or prevent changing of data stored in the database 12. The database can be accessible via the signature service 814 and the data service 816. For example, similar to the system 10 as previously described with respect to FIG. 2, a server 26 on the validation system 802 can process data requests and access the database 12 to compare authorized user data to the credentials provided directly via the agent 804 or via the verification service 808. In some examples, both the first and second credentials are communicated via the data service 816.

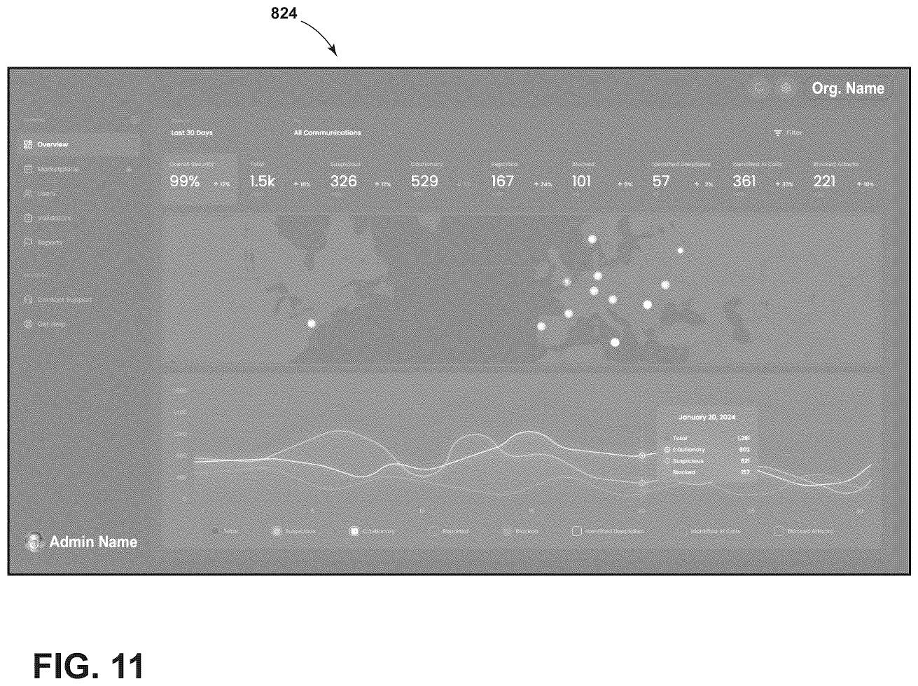

As shown in FIG. 10-12, the validation system 802 can include a portal 824 operable by an administrator of an organization. For example, an information technology (IT) administrator of the organization may operate the portal 824 to manage the system 10. At the portal 824, the confidence level of each agent 804 can be tracked, certificates can be monitored, and other diagnostics of the system 10 can be viewed and logged. As shown in FIG. 11, the portal 824 can allow for monitoring and tracking a number of threats, compromised user devices 806, etc.

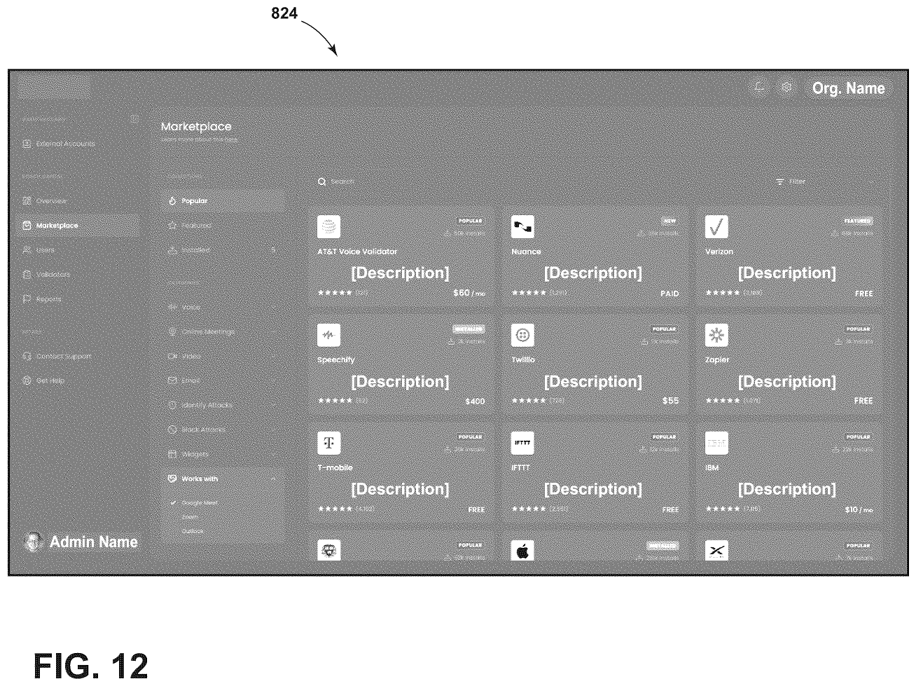

Referring now to FIG. 12, the portal 824 can provide for a virtual marketplace for selection of a plurality of verification services 808. In operation, the administrator can select any of the plurality of verification services 808 for installation at the agents 804. Once selected, the selected service 808 can be pushed to the user devices 806 for installation and interfacing with the verification service 808. In this way, the system 10 can receive verification signals/values from third-party service providers and amalgamated by the validation system 802 with other credentials monitored by the validation system 802 directly. For example, and with brief reference back to FIG. 10, the validators 16 can amalgamate the first and second credentials and weight some credentials (e.g., authentication factors) more than others to determine the confidence level.

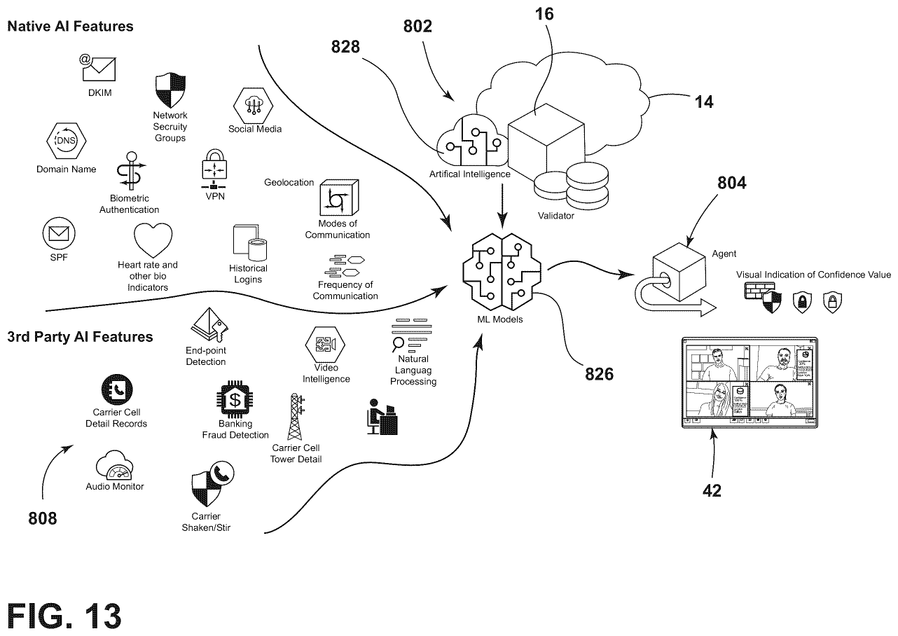

Referring now to FIG. 13, the authentication factors, or credentials, can be processed natively (e.g., on the validators 16) or via the verification services 808 in one or more machine learning models 826 trained by an artificial intelligence engine 828. The models 826 can be trained to generate the confidence value based on the credentials, consistent with the models previously described in reference to FIG. 2. The at least one machine learning model 826 is configured to adjust a function for determining the confidence value by adjusting a relative functional weight of at least one of the data (e.g., native credentials) and the second credential (e.g., third-party verifications). For example, the models 826 can be trained by the AI engine 828 based on EDR detection from the verification (e.g., detection of aberrant software) to better determine the confidence level. For example, a relative weight of the EDR detection verification can be adjusted based on other authentication factors of the system 10 and/or user feedback or manual override (e.g., manual administrator approval of a user or node). In some examples, an EKG of a user can be used as the verification, as the EKG can act as a biometric signature of a person. Thus, the third-party verification service can include a heartrate monitoring system that is trained using AI and/or using the models 826 to detect an identity of a user associated with a given agent 804. As shown in FIG. 13, the number of authentication factors processed by the validation system 802 can include any of the authentication factors previously described.

By way of example, a third-party verification system may include biometric data of a user of the agent 804. For example, the system 10 can communicate with smart watches or smart devices configured to monitor user health, such as heartrate or heartbeat. This monitoring technology can verify the biometric data of the person to enhance identification. The presence of a heartbeat can confirm that an actual person is logging in. Thus, the third-party verification service 808 can be the presence of a heartbeat at a location near the user device 806 being verified, heartrate information specific to an assigned user, an electrocardiogram specific to a user assigned to the user device 806, or the like. Thus, biometric data can be used as the third-party verification. As previously described, the EKG information can be used to identify the user to whom the agent 804 is registered, and relative weights of the determination function of the validation system 802 can be adjusted based on the reliability of the EKG identification. Alternatively, or additionally, the watches can receive notifications for PSTN or VOIP calls, which can be used to verify the user.

Another example of a verification service 808 includes an automatic speech recognition (ASR) service to determine if voice is real or artificial. For example, the service 808 can be used to classify audio waveforms as organic or synthetic. This service 808, as well as the other services 808 described herein, may offer an API or another integration mechanism previously described to interface with the agent 804.

Another example of a verification service 808 that may be integrated into the system 10 includes a telephone carrier service (such as ATT or Verizon) that has access to Call Detail Records (CDR) of many users and can share those to correlate with the CDRs of the calling party. For example, a CDR of a participant (e.g., employee) of an organization implementing the system 10 can be compared to location information detected from GPS or geolocation information. For example, as part of the subscription to the system 10, the CDRs of the user devices 806 can be shared with the validation system 802 to improve the confidence level/score of the users for a given virtual meeting or user identity. Furthermore, the carrier can share geolocation of the caller and can also share data of the location of a cell tower in use by a voice caller (and the series of cell towers if the user is in motion) to help confirm identity and/or improve the confidence value. The carrier could employ secure telephone identity revisited (STIR) and signature-based handling of asserted information using tokens (SHAKEN) protocols to further validate users. Such protocols can be employed to limit caller ID spoofing on public telephone networks. For example, in the event an authentication is done over a call, robo-callers or other malicious actors can be limited by using the CDR verification via third-party.

Another exemplary verification service 808 includes an endpoint detection service. For example, a Cisco® endpoint detection and response (EDR) system may be a third-party verification service 808 in communication with the agent 804. The EDR can detect malware and ransomware on the user device 806. The EDR results can be communicated as the verification to the validation system 802 for amalgamation with other datapoints (e.g., authentication factors) for threat detection and modification of the confidence value. EDR can be implemented via third parties such as Cisco®, CrowdStrike®, or other cybersecurity endpoint experts that use multiple data points focused on detecting various forms of malware. The validation system 802 can gather data this data from these verification services 808 that the given user device 806 is healthy and has had recent signature updates.

Another exemplary verification service 808 can include fintech security measures, such as a decentralized identity (DID) system, such as Orange by MicroStrategy®. By way of example in an email example, a user can prepare an email. When sent, the email is hashed and signed with the sender's private key. The signature is included in the header. At the recipient, the signature and the identifier are retrieved from the email. A verifier then locates the sender's public key using blockchain to verify the signature. The public key is used to decrypt the signature with the public key to give the hash of the email. The DID system can determine whether the email has been tampered with by comparing the hashes. In this way, the DID system can be used to authenticate communications and provide the verification.

Another exemplary verification service 808 includes Ethereum Name Service (ENS) that utilizes blockchain typically for financial transactions. The ENS verification service 808 provides for a decentralized name lookup service. Thus, a user of the user device 806 could have a .eth identifier associated with a financial account (e.g., Ethereum). Accordingly, signed/verified transactions with identifier information associated with the user device 806 can be used to verify the user device 806 or agent 804.

Yet another exemplary verification service 808 includes ordinal inscription for blockchain, which can allow financial transactions to include extra data including a sequential ordering of transactions, which can establish the precise order of transactions within a block and enhancing accuracy of the ledger. Accordingly, financial transactions or other communications tracked via a third-party application utilizing ordinals can be used by the third party to provide the verification to the validation system 802.

Another exemplary verification service 808, which can additionally or alternatively be provided by the private validators 16 of the validation system 802, can be provided via instant messaging (e.g., messaging applications such as SMS, Apple® iMessage, or the like), or web applications, voice (e.g., PSTN, VOIP) rather than traditional multi-factor authentication or FIDO authentication methods. In cases in which no visual indication of the confidence level is possible, the confidence value can be communicated via push notifications (e.g., textual confirmation).

As isolated services, these verification services 808 and others may be challenging to implement efficiently. However, the present system 10 and corresponding methods can provide for enhanced security by providing a centralized platform that can be customized based on selection of the services 808.

As previously described, the system 10 can incorporate federating capabilities. For example, a first node that is using the private validators 16 for user authentication can require display of the confidence levels of users on the communication platform, whereas a third node that is on a public validation system may not have access to confidence levels of the users on the federated network. The verification service 808, for example, may be limited from accessing the confidence level 804 produced by the system 10 (e.g., the validation system 802), while the validation system 802 can have access to and may display the verification from the verification service 808 to users on the federated network. Thus, the system 10 can selectively share confidence levels of nodes via the federation network.

With continued reference to FIG. 13, the models 826 can be used to determine a reliability score for the verification provided by the third party. For example, each service 808 could be scored based on feedback from the native features and or any of the plurality of third-party verification services 808. For example, if a majority of the authentication factors (e.g., first or second credentials) being monitored strongly indicate a high confidence score, while the verification from one verification service 808 is very low, the validation system 802 can rank that verification service 808 lower. Thus, the validation system 802 can include a feedback loop for determining the accuracy of the plurality of verification services 808. For example, the validation system 802 can be configured to determine a reliability score for the verification service 808 based on the weight for the second credential from that verification service 808 and present, at the portal 824, an indication of the reliability score. The validation system 802 can then recommend an alternative verification service 808 of the plurality of verification services 808 based on the reliability score. For example, if a first audio verification service is ranked low by the validation system 802, another audio verification service can be highlighted or otherwise indicated as an alternative.

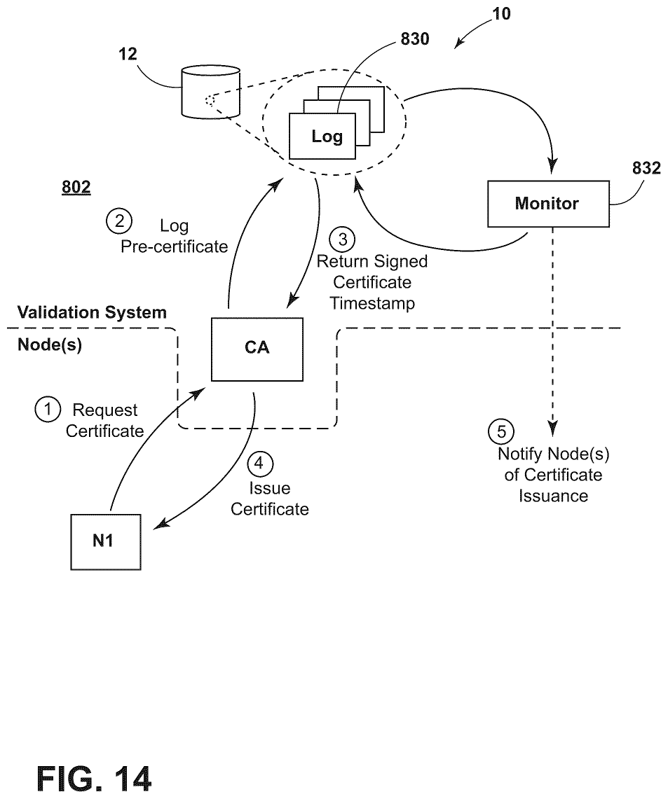

Referring now to FIG. 14, the validation system 802 can include a verifiable system design that incorporates at least one of certificate transparency and a claimant model for verification. The verifiable system design can be used to verify the agents 804 of the system 10. Accordingly, the node N1 can be demonstrative of a verification service 808 or a native user device 806. In general, the certificate transparency is demonstrated in steps 1-5. At step 1, the node requests a certificate from the certificate authority CA. The CA can be part of the validation system 802, such as the server 26, a validator 16, or another computing device of the validation system 802. The CA then verifies that the agent 804 or third-party verification service 808 is what it purports to be (e.g., via the signature service 814) and logs a pre-certificate in a log 830 at step 2. The log 830 can be append-only and may or may not be incorporated into the same database 12 previously described. The log 830 can utilize a Merckle tree to track the pre-certificates and generally contain immutable data. At step 3, the pre-certificate is signed and timestamped to become a certificate, which is then issued by the CA to node N1 at step 4. Concurrent to at least one of steps 1-4 (e.g., periodically), the log 830 is monitored by a monitor 832, and certificate issuances are communicated to other nodes of the system 10. In some examples, the monitor 832 is a separate evaluation unit that audits the validation system 802 to detect malicious entries in the log 830, thereby detecting malicious certificates. By way of example, malicious certificates may be detected by the monitor 832 by cryptographically monitoring the log 830.

In some examples, the monitor 832 is run by the validation system 802 and the node N1 is the third-party verification service 808. In this example, the monitor 832 checks the certificates of the verification services 808 periodically to ensure that the verification services 808 are what they purport to be. It is contemplated that monitoring functionality in this context can further be selected in the virtual marketplace. For example, the system 10 can be configured to present the verification services 808 and an option to monitor the verification service 808 for an additional cost.

In some examples, the validation system 802 employs a claimant model which may be additional to or alternative to the certificate transparency protocol. Similar to the example above, the claimant of the claimant model can be the agent 804 or a verification service 808. The claimant of the claimant model publishes a manifest (e.g., to the log 830) to claim to have a cryptographic hash unique for a specified version (e.g., an operating system version or version of the agent 804) and a claim that the claimant is functionally correct and without known attack vectors. For example, the agent 804 can communicate the claim to the validators 16 using the signature service 814. The validation system 802 can be configured to act as a believer of the claim and issue a certificate to the agent 804. However, in the event that the private keys of the agent 804 are stolen and a false or malicious manifest is published, because the manifests are published, the claimant can monitor the published manifests to detect a malicious manifest. Accordingly, the claimant model includes a verifier, which can verify or approve the claim described by each manifest. Accordingly, the monitor 832, another computing device of the validation system 802, or administrators of the system 10 can verify the manifest. In this way, false certificates of agents 804 can be flagged by the system 10 and blocked from communication of the data service 816. In some examples, in response to detection of an aberrant manifest, the portal 824 is configured to present an indication of the aberrant manifest, and validation system 802 is configured to revoke the certification in response to detection of the aberrant manifest.

The methods executed by the system 10 can provide non-repudiation by ensuring validation of communications sent or received. The non-repudiation can be provided via asymmetric key pairs, amalgamating the features (e.g., first and second credentials) from the native system and the third-party system, certificate transparency logs, immutable data, or any combination thereof.

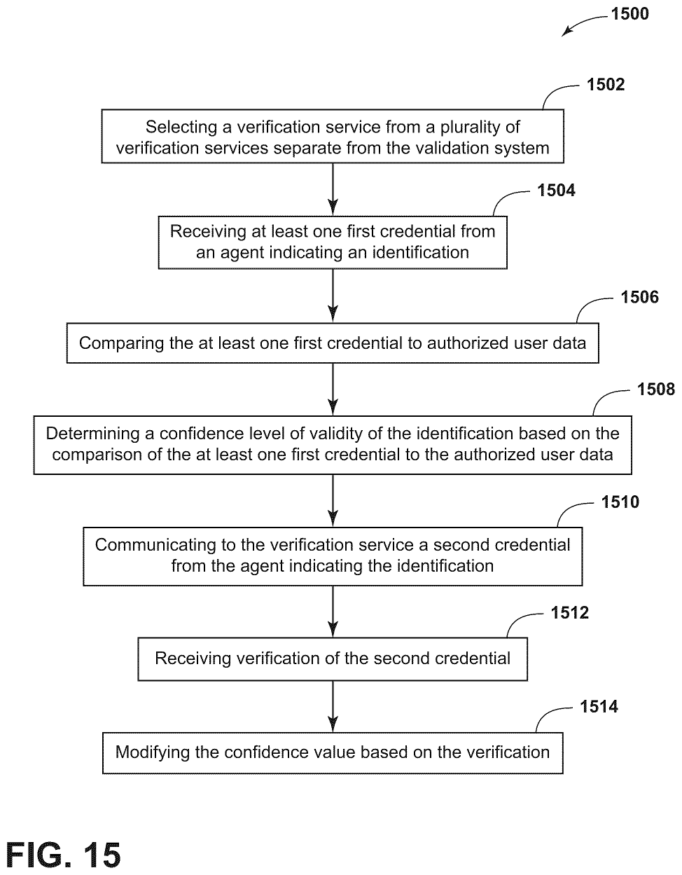

Referring now to FIG. 15, a method 1500 of authentication may be performed by the system 10. The method 1500 includes selecting, via a portal 824 of a validation system 802, a verification service 808 from a plurality of verification services 808 separate from the validation system 802 at step 1502. At step 1504, the method 1500 includes receiving, at a validation system 802, at least one first credential from an agent 804 indicating an identification. At step 1506, the method 1500 includes comparing the at least one first credential to authorized user data stored in an authorized user database 12. At step 1508, the method 1500 includes determining a confidence level of validity of the identification based on the comparison of the at least one first credential to the authorized user data. At step 1510, the method 1500 includes communicating to the verification service 808 a second credential from the agent 804 indicating the identification. At step 1512, the method 1500 includes receiving, via the verification service 808, verification of the second credential. At step 1514, the method 1500 includes modifying the confidence level based on the verification.

The misuse of deepfake technology for malicious purposes, such as corporate espionage, theft of assets, spreading disinformation, forging evidence, or manipulating public opinion, poses a significant threat to society. As deepfakes become increasingly realistic and harder to detect, the risk of causing chaos, confusion, and harm amplifies. The system 10 and methods of the present disclosure provide mechanisms to limit or eliminate these effects.

It is contemplated that the various processing systems (e.g., validation and verification systems) described herein can include any number of processors and memories part of control circuitry. The control circuitry can include one or more controllers that incorporate at least one processor and memory-storing instructions that, when executed by the processor, cause the processor to perform actions and/or communicate signals for authentication. The processors can include one or more general-purpose processing devices such as a microprocessor, central processing unit, or the like. The processors may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device may also be one or more special-purpose processing devices such as an application-specific integrated circuit (ASIC), a system on a chip, a field programmable gate array (FPGA), a digital signal processor (DSP), network processor, or the like. The processors may be configured to execute instructions for performing any of the operations and steps discussed herein. For example, the system 10 described here in can include one or more tangible, non-transitory computer-readable medium storing instructions that, when executed, cause one or more processing devices to perform the steps herein.

The present disclosure provides for various combinations of the following aspects:

According to one aspect of the present disclosure, a system for authentication includes a validation system and an agent configured to communicate a first credential indicating an identification to the validation system and communicate a second credential indicating the identification to a verification service. The validation system includes a database configured to store authorized user data and a portal configured to provide selection of the verification service from a plurality of verification services. The validation system is configured to compare the first credential to the authorized user data, determine a confidence level of validity of the identification based on the comparison of the first credential to the authorized user data, receive a verification of the second credential from the verification service, and modify the confidence level based on the verification.

According to one aspect of the present disclosure, the system includes at least one application programming interface (API) communicatively coupling the verification service with the agent and the validation system.

According to one aspect of the present disclosure, the at least one API includes a first API at the validation system and a second API installed on a machine on which the agent is running.

According to one aspect of the present disclosure, the verification service interfaces with the agent via a software development kit (SDK).

According to one aspect of the present disclosure, the verification service interfaces with the agent via a webhook.

According to one aspect of the present disclosure, the verification service interfaces with the agent via a web service.

According to one aspect of the present disclosure, the verification service includes endpoint service and detection.

According to one aspect of the present disclosure, the plurality of verification services is presented via a virtual marketplace via the portal.

According to one aspect of the present disclosure, the validation system is configured to determine a deepfake condition in response to the confidence level.

According to one aspect of the present disclosure, the authorized user data includes immutable data stored on the database.

According to one aspect of the present disclosure, the system includes a user device on which the agent runs, wherein the first credential includes data representative of an identity of the user device, the data including at least one of location information, voice information, and video information.

According to one aspect of the present disclosure, the validation system includes at least one machine learning model trained to generate the confidence level based on the first credential and the second credential.

According to one aspect of the present disclosure, the system includes an artificial intelligence engine that trains the machine learning model using the first credential and the verification.

According to one aspect of the present disclosure, the machine learning model is configured to adjust a function for determining the confidence level by adjusting a relative functional weight of at least one of the first credential and the second credential.

According to one aspect of the present disclosure, the validation system is configured to determine a reliability score for the verification service based on the weight for the second credential and present, at the portal, an indication of the reliability score.

According to one aspect of the present disclosure, the validation system is configured to recommend an alternative verification service of the plurality of verification services based on the reliability score.

According to one aspect of the present disclosure, the second credential includes biometric data of a user of the agent.

According to one aspect of the present disclosure, the biometric data includes at least one of a heartrate and an electrocardiogram, and wherein the verification service includes a heartrate monitoring system for the user.

According to one aspect of the present disclosure, the validation system includes at least one machine learning model trained to generate the confidence level based on the electrocardiogram of a user to whom the agent is registered.

According to one aspect of the present disclosure, the heartrate monitoring system is configured to identify the user based on the electrocardiogram.

According to one aspect of the present disclosure, the system includes an artificial intelligence engine that trains the machine learning model using the electrocardiogram.

According to one aspect of the present disclosure, the machine learning model is configured to adjust a function for determining the confidence level by adjusting a relative functional weight of at least one of the first credential and the electrocardiogram.

According to one aspect of the present disclosure, the user device is configured to run a conferencing software or an email application that presents the confidence level.

According to one aspect of the present disclosure, the verification includes at least one of a textual confirmation via an instant messaging application running on the user device and data from a web application running on the user device.

According to one aspect of the present disclosure, the credential includes voice information provided via at least one of VOIP and PSTN.

According to one aspect of the present disclosure, the verification service is a third-party service separate from the validation system.

According to one aspect of the present disclosure, the validation system provides certificate transparency.

According to one aspect of the present disclosure, the validation system employs a claimant model for verifying signatures of the agent.

According to one aspect of the present disclosure, a method for authentication includes selecting, via a portal of a validation system, a verification service from a plurality of verification services separate from the validation system, receiving, at the validation system, a first credential from an agent indicating an identification, comparing the first credential to authorized user data stored in an authorized user database, determining a confidence level of validity of the identification based on the comparison of the first credential to the authorized user data, communicating to the verification service a second credential from the agent indicating the identification, receiving, via the verification service, verification of the second credential, and modifying the confidence level based on the verification.

According to one aspect of the present disclosure, the method includes presenting at the portal, the plurality of verification services via a virtual marketplace.

According to one aspect of the present disclosure, the method includes determining a deepfake condition in response to the confidence level.

According to one aspect of the present disclosure, the method includes training, via an artificial intelligence engine, at least one machine learning model to generate the confidence level based on the first credential and the second credential.

According to one aspect of the present disclosure, the method includes adjusting a function for determining the confidence level by adjusting a relative functional weight of the first credential and the second credential.

According to one aspect of the present disclosure, the method includes determining a reliability score for the verification service based on the weight for the second credential and present, at the portal, an indication of the reliability score.

According to one aspect of the present disclosure, the method includes recommending, via the validation system, an alternative verification service of the plurality of verification services based on the reliability score.

According to one aspect of the present disclosure, a method for authentication includes selecting a verification service from a plurality of verification services, receiving, at a validation system, a first credential from an agent indicating an identification, comparing the first credential to authorized user data, determining a confidence level of validity of the identification based on the comparison of the first credential to the authorized user data, communicating to the verification service a second credential indicating the identification, receiving a verification of the second credential from the verification service, and modifying the confidence level based on the validation.

According to one aspect of the present disclosure, determining a deepfake condition in response to the confidence level.

According to one aspect of the present disclosure, a system for identity authentication on a communication platform, comprising, a database configured to store authorized user data, a first node that creates an identification and is configured to communicate the identification. At least one second node configured to receive the identification, compare the identification to the authorized user data, determine a confidence level for the first node, and communicate a signal indicating the confidence level, and a user interface configured to present an indication of the confidence level in response to the signal.

According to one aspect of the present disclosure, the first node is configured to communicate a credential to a verification service, and wherein the at least one second node is configured to receive a verification from the verification service based on the credential.

According to one aspect of the present disclosure, the validation system is configured to modify the confidence level based on the verification.

According to one aspect of the present disclosure, the system includes at least one application programming interface (API) communicatively coupling the verification service with the first node and the at least one second node.

According to one aspect of the present disclosure, the system includes a portal to allow selection of a plurality of verification services presented via a virtual marketplace.

According to one aspect of the present disclosure, the authorized user data includes immutable data stored on the database.

According to one aspect of the present disclosure, the identification is post-quantum secure.

According to one aspect of the present disclosure, the at least one second node is communicatively coupled with a blockchain for verifying the identification.

According to one aspect of the present disclosure, the communication platform includes conferencing software configured to present the confidence level, wherein the confidence level is representative of user authentication for users of the conferencing software.

According to one aspect of the present disclosure, the communication platform includes email communication software.

According to one aspect of the present disclosure, the data includes at least one of a textual confirmation via an instant messaging application running on the user device and data from a web application running on the user device.

According to one aspect of the present disclosure, the voice information is provided via at least one of VOIP and PSTN.

According to one aspect of the present disclosure, a system for identity authentication on a communication platform, comprising a database configured to store authorized user data. A first node configured to communicate the identification, and communicate a credential to a verification service. At least one second node configured to receive the identification, compare the identification to the authorized user data, determine a confidence level for the first node, receive a verification from the verification service based on the credential, update the confidence level based on the verification, and communicate a signal indicating the confidence level, and a user interface configured to present an indication of the confidence level in response to the signal.

According to one aspect of the present disclosure, a system for authentication includes a validation system, an agent configured to communicate a first credential indicating an identification to the validation system and communicate a second credential indicating the identification to a verification service. The validation system includes a database configured to store authorized user data, and a portal configured to provide selection of the verification service from a plurality of verification services, wherein the validation system is configured to compare the first credential to the authorized user data, determine a confidence level of validity of the identification based on the comparison of the first credential to the authorized user data, receive a verification of the second credential from the verification service, and modify the confidence level based on the verification.

According to one aspect of the present disclosure, the verification service includes a carrier, and wherein the second credential includes call detail records.

According to one aspect of the present disclosure, the call detail records include a cell tower location.

According to one aspect of the present disclosure, the carrier is configured to employs at least one of a secure telephone identity revisited (STIR) protocol and a signature-based handling of asserted information using tokens (SHAKEN) protocol to determine the verification.

According to one aspect of the present disclosure, the system includes a signature service between the validation system and the agent, wherein the signature service employs a verifiable data structure.

According to one aspect of the present disclosure, the system includes a certificate authority configured to issue certificates to the agent via the signature service, a log configured to log pre-certificates, and a monitor configured to monitor the log.

According to one aspect of the present disclosure, the log is append-only and transparent.

According to one aspect of the present disclosure, the monitor is configured to detect malicious certificates.

According to one aspect of the present disclosure, the log utilizes a Merckle tree to track the pre-certificates.

According to one aspect of the present disclosure, the validation system provides certificate transparency.

According to one aspect of the present disclosure, the validation system employs a claimant model for verifying signatures of the agent.

According to one aspect of the present disclosure, the system includes a certificate authority configured to publish a manifest when a certificate is issued to the agent.

According to one aspect of the present disclosure, the system includes a verifier configured to verify the manifest from the certificate authority.

According to one aspect of the present disclosure, in response to detection of an aberrant manifest, the portal is configured to present an indication of the aberrant manifest.

According to one aspect of the present disclosure, the validation system is configured to revoke the certification in response to detection of the aberrant manifest.

According to one aspect of the present disclosure, the verification service is a third-party service separate from the validation system.

According to one aspect of the present disclosure, a system for identity authentication on a communication platform includes a database configured to store authorized user data, a first node that creates an identification and is configured to communicate the identification. At least one second node configured to receive the identification, compare the identification to the authorized user data, determine a confidence level for the first node, and communicate a signal indicating the confidence level, and a user interface configured to present an indication of the confidence level in response to the signal.

According to one aspect of the present disclosure, the system includes a signature service between the first node and the at least one second node, wherein the signature service employs a verifiable data structure.

According to one aspect of the present disclosure, the system includes a certificate authority configured to issue certificates to the first node via the signature service, a log configured to log pre-certificates, and a monitor configured to monitor the log.

According to one aspect of the present disclosure, the log is append-only and transparent.

According to one aspect of the present disclosure, the monitor is configured to detect malicious certificates.

According to one aspect of the present disclosure, the validation system employs a claimant model for verifying signatures of the first node.

According to one aspect of the present disclosure, the system includes a certificate authority configured to publish a manifest when a certificate is issued to the first node.

According to one aspect of the present disclosure, the system includes a verifier configured to verify the manifest from the certificate authority.

According to one aspect of the present disclosure, the identification is post-quantum secure.

According to one aspect of the present disclosure, the at least one second node is communicatively coupled with a blockchain for verifying the identification.

According to one aspect of the present disclosure, the communication platform includes conferencing software configured to present the confidence level, wherein the confidence level is representative of user authentication for users of the conferencing software.

According to one aspect of the present disclosure, the communication platform includes email communication software.

According to one aspect of the present disclosure, the identification includes at least one of a textual confirmation via an instant messaging application and data from a web application.

According to one aspect of the present disclosure, the identification includes at least one of voice information provided via at least one of VOIP and PSTN, textual confirmation via instant messaging, video information, and location information.

According to one aspect of the present disclosure, the system includes a third-party verification service in communication with the first node and includes endpoint service and detection for detecting aberrant software running on the first node.

According to one aspect of the present disclosure, the at least one second node includes at least one machine learning model trained to generate the confidence level based on detection of the aberrant software.

According to one aspect of the present disclosure, the system includes an artificial intelligence engine that trains the machine learning model using the detection of the aberrant software.

According to one aspect of the present disclosure, the machine learning model is configured to adjust a function for determining the confidence level by adjusting a relative functional weight of at least one of the verifications from the endpoint service and detection.

According to one aspect of the present disclosure, the system is configured to provide a decentralized identity via sharing the confidence level and detail with a different set of federated nodes.

According to one aspect of the present disclosure, the at least one second node includes a federated network, and further comprising a third node on the federated network, and wherein the first node is connected to the at least one second node from outside of the federated network, wherein the at least one second node is configured to limit communication of the confidence level of the third node in response to the first node being outside of the federated network.

According to one aspect of the present disclosure, the third-party verification service is configured to share the verification and the at least one second node is configured to limit communication of the confidence level to the third-party verification service.

According to one aspect of the present disclosure, the at least one second node is configured to selectively share confidence levels of nodes via a federation network.

According to one aspect of the present disclosure, the at least one second node is configured to selectively limit communication of the confidence level based on the comparison of the identification to the authorized user data.

According to one aspect of the present disclosure, the system is configured to provide a decentralized identity via sharing the confidence level and detail with a different set of federated nodes.

According to one aspect of the present disclosure, the at least one second node is configured to determine a security level corresponding to the identification based on the comparison of the identification to the authorized user data.

According to one aspect of the present disclosure, a method for transmitting a secure authentication request to authenticate audio and/or video files or streams from a first node to a second node includes a system having a first node that creates a secure identification that is transmitted to a second node and a second node that verifies the secure identification as matching the identification of a known contact or not matching the known contact (either because it is an imposter, or the contact is not employing the secure identification technology).

According to one aspect of the present disclosure, the secure authentication employs public-private key encryption.

According to one aspect of the present disclosure, the secure authentication employs a zero-knowledge proof protocol.

According to one aspect of the present disclosure, the secure authentication employs a Post-quantum cryptography method such as ZK-Stark.

According to one aspect of the present disclosure, the request to authenticate employs in-band audio tones for key exchange.

According to one aspect of the present disclosure, a plugin or API is employed to interface with the calendar and/or meeting service to compare to a datastore.

According to one aspect of the present disclosure, the first node samples the streaming data as a spectrogram to confirm the session and the participants in a call/meeting match the scheduled participants.

According to one aspect of the present disclosure, the keys are rotated on a periodic basis, and presentation of a key on an inappropriate time to detect if they are potentially deep fakes.

According to one aspect of the present disclosure, to identify participants to categorize if they are new, have previously exchanged keys, have no keys or mismatched key to detect if they are potentially deep fakes.

According to one aspect of the present disclosure, the request to authenticate is out-of-band from the audio and/or video files or streams via a separate data stream.

According to one aspect of the present disclosure, the API provides information such as IP addresses, open ports to identify the OS, device type, and manufacturer.

According to one aspect of the present disclosure, the IP address of the remote node can be compared to the SWIP database to determine the location of the remote node.

According to one aspect of the present disclosure, the systems and methods described herein are configured to log user identification exchanges for tracking on an audit trail.

According to one aspect of the present disclosure, the logging and audit trail are stored on a cryptographic blockchain.

According to one aspect of the present disclosure, the logging and audit trail is transmitted to a database.

According to one aspect of the present disclosure, the systems and methods described herein are configured for transmitting billing information to a database using post-quantum secure authentication.

According to one aspect of the present disclosure, a system for identity authentication on a communication platform includes a database configured to store authorized user data. The system includes a first node that creates an identification and is configured to communicate the identification. The at least one-second node is configured to receive the identification, compare the identification to the authorized user data, determine a confidence level for the first node, and communicate a signal indicating the confidence level. The system includes a user interface configured to present an indication of the confidence level in response to the signal.

According to one aspect of the present disclosure, the at least one second node includes a plurality of validating nodes each configured to verify the identification redundantly.

According to one aspect of the present disclosure, the plurality of validating nodes includes a first validating node and a second validating node each configured to validate the identification, wherein the second validating node is configured to verify the identification in an event of inoperability of the first validating node.

According to one aspect of the present disclosure, the plurality of validating nodes form a network of validators, and the network is configured to scale by communicatively coupling the plurality of validating nodes to added validating nodes.

According to one aspect of the present disclosure, the first node is configured to communicate the identification to the at least one-second node via at least one of a public network and a private network.

According to one aspect of the present disclosure, the at least one second node is configured to limit communication of an identification proof of the at least one second node to the first node in response to the first node communicating via the public network.

According to one aspect of the present disclosure, the at least one second node is configured to communicate identification verification of the at least one second node to the first node in response to the first node communicating via the private network.

According to one aspect of the present disclosure, the system includes a federated identity provider configured to selectively require communication of the identification verification based on the first node communicating via the private network or the public network.

According to one aspect of the present disclosure, the identification is post-quantum secure.

According to one aspect of the present disclosure, the first node and the at least one second node form a zero-knowledge scalable transparent argument of knowledge (ZK-STARK).

According to one aspect of the present disclosure, the first node communicates the identification in the form of a zero-knowledge proof (ZKP).

According to one aspect of the present disclosure, the at least one second node includes a verifier for the ZKP.

According to one aspect of the present disclosure, the system includes at least one validator configured to validate the ZKP.

According to one aspect of the present disclosure, the at least one second node is communicatively coupled with a blockchain for verifying the identification.

According to one aspect of the present disclosure, the identification is created via a polynomial commitment scheme.

According to one aspect of the present disclosure, the communication platform includes conferencing software configured to present the confidence level, wherein the confidence level is representative of user authentication for users of the conferencing software.

According to one aspect of the present disclosure, the at least one second node is configured to request the identification, and the identification includes audio communication for key exchange.

According to one aspect of the present disclosure, the request employs in-band audio tones to verify the identification.

According to one aspect of the present disclosure, the in-band audio tones are adjusted periodically during a virtual conference on the conferencing software.

According to one aspect of the present disclosure, the in-band audio tones are above hearing range.

According to one aspect of the present disclosure, the audio communication includes voice audio of a user of the conferencing software sampled by the at least one second node to verify the identification.

According to one aspect of the present disclosure, the identification includes video communication via the conferencing software for key exchange.

According to one aspect of the present disclosure, the video communication includes video data representative of a user of the conferencing software, and the at least one second node is configured to verify the video data as representing the user via comparison of the identification to the authorized user data.

According to one aspect of the present disclosure, the identification is via out-of-band communication relative to video and audio streaming on the conferencing software.

According to one aspect of the present disclosure, the out-of-band communication includes communication of at least one of IP address data and operating system information.

According to one aspect of the present disclosure, the authorized user data includes authorized IP addresses, and wherein the comparison of the identification to authorized user data includes a comparison of the IP address data to the authorized IP addresses.

According to one aspect of the present disclosure, the communication platform includes email communication software.

According to one aspect of the present disclosure, the at least one second node is configured to selectively limit communication of the confidence level based on the comparison of the identification to the authorized user data.

According to one aspect of the present disclosure, the at least one second node is configured to selectively limit communication of a level of verification detail for the confidence level based on the comparison of the identification to the authorized user data.

According to one aspect of the present disclosure, the at least one second node is configured to determine a security level corresponding to the identification based on the comparison of the identification to the authorized user data.

According to one aspect of the present disclosure, the system is configured to provide a decentralized identity via sharing the confidence level and detail with a different set of federated nodes.

According to one aspect of the present disclosure, the system includes an artificial intelligence engine configured to train at least one machine learning model using past authentications.

According to one aspect of the present disclosure, the machine learning model is trained to determine the confidence level based on the past authentications.

According to one aspect of the present disclosure, a method for identity authentication on a communication platform includes communicating, via a first node to at least one second node, an identification, receiving, at the at least one second node, the identification, comparing the identification to authorized user data stored in a database storing the authorized user data, determining a confidence level for the first node, and communicating a signal indicating the confidence level, and presenting, at a user interface, an indication of the confidence level in response to the signal.

According to yet another aspect of the present disclosure, a system for identity authentication on a conferencing platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication on an email communication platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A system for authentication, comprising:
a validation system;
an agent configured to communicate a first credential indicating an identification to the validation system and communicate a second credential indicating the identification to a verification service, wherein the validation system includes:
a database configured to store authorized user data; and
a portal configured to provide selection of the verification service from a plurality of verification services, wherein the validation system is configured to compare the first credential to the authorized user data, determine a confidence level of validity of the identification based on the comparison of the first credential to the authorized user data, receive a verification of the second credential from the verification service, and modify the confidence level based on the verification.

2. The system of claim 1, wherein the verification service includes a carrier, and wherein the second credential includes call detail records.

3. The system of claim 2, wherein the call detail records include a cell tower location.

4. The system of claim 2, wherein the carrier is configured to employs at least one of a secure telephone identity revisited (STIR) protocol and a signature-based handling of asserted information using tokens (SHAKEN) protocol to determine the verification.

5. The system of claim 1, further comprising:
a signature service between the validation system and the agent, wherein the signature service employs a verifiable data structure.

6. The system of claim 1, further comprising:
a certificate authority configured to issue certificates to the agent via the signature service;
a log configured to log pre-certificates; and
a monitor configured to monitor the log.

7. The system of claim 6, wherein the log is append-only and transparent.

8. The system of claim 6, wherein the monitor is configured to detect malicious certificates.

9. The system of claim 1, wherein the log utilizes a Merckle tree to track the pre-certificates.

10. The system of claim 1, wherein the validation system provides certificate transparency.

11. The system of claim 1, wherein the validation system employs a claimant model for verifying signatures of the agent.

12. The system of claim 11, further comprising:
a certificate authority configured to publish a manifest when a certificate is issued to the agent.

13. The system of claim 12, further comprising:
a verifier configured to verify the manifest from the certificate authority.

14. The system of claim 13, wherein, in response to detection of an aberrant manifest, the portal is configured to present an indication of the aberrant manifest.

15. The system of claim 13, wherein the validation system is configured to revoke the certification in response to detection of the aberrant manifest.

16. The system of claim 1, wherein the verification service is a third-party service separate from the validation system.

17. A system for identity authentication on a communication platform, comprising:
a database configured to store authorized user data;
a first node that creates an identification and is configured to communicate the identification;
at least one second node configured to:
receive the identification;
compare the identification to the authorized user data;
determine a confidence level for the first node; and
communicate a signal indicating the confidence level; and
a user interface configured to present an indication of the confidence level in response to the signal.

18. The system of claim 17, further comprising:
a signature service between the first node and the at least one second node, wherein the signature service employs a verifiable data structure.

19. The system of claim 18, further comprising:
a certificate authority configured to issue certificates to the first node via the signature service;
a log configured to log pre-certificates; and
a monitor configured to monitor the log.

20. The system of claim 19, wherein the log is append-only and transparent.

21. The system of claim 19, wherein the monitor is configured to detect malicious certificates.

22. The system of claim 18, wherein the validation system employs a claimant model for verifying signatures of the first node.

23. The system of claim 18, further comprising:
a certificate authority configured to publish a manifest when a certificate is issued to the first node.

24. The system of claim 23, further comprising:
a verifier configured to verify the manifest from the certificate authority.

25. The system of claim 18, wherein the identification is post-quantum secure.

26. The system of claim 18, wherein the at least one second node is communicatively coupled with a blockchain for verifying the identification.

27. The system of claim 18, wherein the communication platform includes conferencing software configured to present the confidence level, wherein the confidence level is representative of user authentication for users of the conferencing software.

28. The system of claim 18, wherein the communication platform includes email communication software.

29. The system of claim 18, wherein the identification includes at least one of a textual confirmation via an instant messaging application and data from a web application.

30. The system of claim 18, wherein the identification includes at least one of voice information provided via at least one of VOIP and PSTN, textual confirmation via instant messaging, video information, and location information.

31. The system of claim 18, further comprising:
a third-party verification service in communication with the first node and including endpoint service and detection for detecting aberrant software running on the first node.

32. The system of claim 31, wherein the at least one second node includes at least one machine learning model trained to generate the confidence level based on detection of the aberrant software.

33. The system of claim 32, further comprising:
an artificial intelligence engine that trains the machine learning model using the detection of the aberrant software.

34. The system of claim 31, wherein the machine learning model is configured to adjust a function for determining the confidence level by adjusting a relative functional weight of at least one of the verification from the endpoint service and detection.

35. The system of claim 18, wherein the system is configured to provide a decentralized identity via sharing the confidence level and detail with a different set of federated nodes.

36. The system of claim 18, wherein the at least one second node includes a federated network, and further comprising:
a third node on the federated network, and wherein the first node is connected to the at least one second node from outside of the federated network, wherein the at least one second node is configured to limit communication of the confidence level of the third node in response to the first node being outside of the federated network.

37. The system of claim 31, wherein the third-party verification service is configured to share the verification and the at least one second node is configured to limit communication of the confidence level to the third-party verification service.

38. The system of claim 18, wherein the at least one second node is configured to selectively share confidence levels of nodes via a federation network.

39. The system of claim 18, wherein the at least one second node is configured to selectively limit communication of the confidence level based on the comparison of the identification to the authorized user data.

40. The system of claim 18, wherein the system is configured to provide a decentralized identity via sharing the confidence level and detail with a different set of federated nodes.

41. The system of claim 18, wherein the at least one second node is configured to determine a security level corresponding to the identification based on the comparison of the identification to the authorized user data.
